(19) United States
(12) Patent Application Publication
(10) Pub. No.: US 2026/0133930 A1
(43) Pub. Date: May 14, 2026

(54) METHODS AND APPARATUS FOR DATA TRANSFER USING TWO COMMUNICATION PROTOCOLS

(71) Applicant: Texas Instruments Incorporated, Dallas, TX (US)

(72) Inventors: Jayawardan Janardhanan, Bengaluru (IN); Ravinder Sharma, Bangalore (IN); Ravi Kiran Anantha Venkata Aripirala, Bengaluru (IN)

(21) Appl. No.: 19/343,505

(22) Filed: Sep. 29, 2025

(30) Foreign Application Priority Data
Nov. 12, 2024 (IN) 202441086993
Dec. 20, 2024 (IN) 202441101252

(51) Int. Cl. G06F 13/42

(52) U.S. Cl. CPC G06F 13/4291; G06F 2213/0002

(57) ABSTRACT

An example apparatus includes: interface circuitry configured to: receive, from a first host device and using a first communication protocol, a first data packet designated for an endpoint device; after receiving the first data packet, receive, from a second host device and using the first communication protocol, a second data packet designated for the endpoint device; and control circuitry coupled to the interface circuitry, the control circuitry configured to: lock communication between the endpoint device and the first host device; cause the interface circuitry to transmit, using a second communication protocol, the first data packet to the endpoint device; and discard the second data packet.

### CROSS-REFERENCE TO RELATED APPLICATION

This application claims the benefit of and priority to Indian Provisional Patent Application No. 202441086993, filed Nov. 12, 2024, and Indian Provisional Patent Application No. 202441101252, filed on Dec. 20, 2024, which are hereby incorporated herein by reference in their entireties.

### TECHNICAL FIELD

This description relates generally to an electronic system and method, and, in particular embodiments, to a method and apparatus for data transfer using two communication protocols.

### BACKGROUND

Some electrical systems include multiple sensors that capture information and provide the information to a central processing device to perform one or more actions or operations based on the captured sensor information. Such systems may include different components communicating using a serial peripheral interface (SPI). SPI is a widely adopted, synchronous serial communication interface that is typically used in high-speed communication between devices. SPI operates with a peripheral-controller (e.g., master-slave) architecture, where the controller device controls the communication and the peripheral device responds to the commands of the controller. SPI typically includes a serial clock terminal, a peripheral out controller in (POCI) terminal, a peripheral in controller out (PICO) terminal, and a chip select terminal. The serial clock terminal is used by a controller to send out a clock signal to synchronize data transfer. The POCI terminal is used for data transfer from the peripheral to the controller. The PICO terminal is used for data transfer from the controller to the peripheral. The chip select terminal is used by the controller to select which peripheral device to communicate with when multiple peripherals are present.

### SUMMARY

In accordance to an embodiment, an apparatus includes: interface circuitry configured to: receive, from a first host device and using a first communication protocol, a first data packet designated for an endpoint device; after receiving the first data packet, receive, from a second host device and using the first communication protocol, a second data packet designated for the endpoint device; and control circuitry coupled to the interface circuitry, the control circuitry configured to: lock communication between the endpoint device and the first host device; cause the interface circuitry to transmit, using a second communication protocol, the first data packet to the endpoint device; and discard the second data packet.

In accordance to an embodiment, an apparatus includes: interface circuitry configured to receive, from a host device and using a first communication protocol, a lock request to lock communication between an endpoint device and the host device; and control circuitry coupled to the interface circuitry and configured to: cause the interface circuitry to transmit, using a second communication protocol, the lock request to the endpoint device; responsive to an approval of the lock request, cause the interface circuitry to route, using the second communication protocol, a first data packet to the endpoint device, the first data packet received by the interface circuitry from the host device; and responsive to reception of an unlock request to unlock communication between the endpoint device and the host device, cause the interface circuitry to route, using the second communication protocol, the unlock request to the endpoint device.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a block diagram of an example system for transmitting data between a host processor and a target endpoint device, according to an embodiment of the present disclosure;

FIG. 2 is a block diagram illustrating connections between an SPI controller, a flat panel display (FPD) network (which is a type of SerDes network), and an SPI peripheral of FIG. 1, according to an embodiment of the present disclosure;

FIGS. 3A-3C illustrate signal diagrams corresponding to different techniques for transmitting additional data between the SPI controller and the SPI peripheral through the FPD network of FIG. 1, according to an embodiment of the present disclosure;

FIG. 4 is a block diagram corresponding to an SPI write transfer through the SerDes network of FIG. 1, according to an embodiment of the present disclosure;

FIG. 5 is a block diagram corresponding to an SPI read transfer through the SerDes network of FIG. 1, according to an embodiment of the present disclosure;

FIG. 6 is a signal diagram corresponding to a remote SPI write protocol, according to an embodiment of the present disclosure;

FIG. 7 is a signal diagram corresponding to an alternative remote SPI write protocol, according to an embodiment of the present disclosure;

FIG. 8 is a signal diagram corresponding to an alternative remote SPI write protocol, according to an embodiment of the present disclosure;

FIG. 9 is a signal diagram corresponding to an alternative remote SPI write protocol, according to an embodiment of the present disclosure;

FIG. 10 is a signal diagram corresponding to a remote SPI read protocol, according to an embodiment of the present disclosure;

FIG. 11 is a signal diagram corresponding to an alternative remote SPI read protocol, according to an embodiment of the present disclosure;

FIG. 12 is a signal diagram corresponding to an alternative remote SPI read protocol, according to an embodiment of the present disclosure;

FIG. 13 is a signal diagram corresponding to an alternative remote SPI read protocol, according to an embodiment of the present disclosure;

FIG. 14 is a signal diagram corresponding to a remote SPI read and write protocol, according to an embodiment of the present disclosure;

FIG. 15 is a signal diagram corresponding to an alternative remote SPI read and write protocol, according to an embodiment of the present disclosure;

FIG. 16 is a signal diagram corresponding to an alternative remote SPI read and write protocol, according to an embodiment of the present disclosure;

FIG. 17 is a signal diagram corresponding to an alternative remote SPI read and write protocol, according to an embodiment of the present disclosure;

FIG. 18 is a flowchart representative of example machine-readable instructions or example operations that may be at least one of executed, instantiated, or performed using an example programmable circuitry implementation of the SPI controller of FIG. 1, according to an embodiment of the present disclosure;

FIGS. 19A-19B are flowcharts representative of example machine-readable instructions or example operations that may be at least one of executed, instantiated, or performed using an example programmable circuitry implementation of the proxy SPI peripheral of FIG. 1, according to an embodiment of the present disclosure;

FIGS. 20-21 are flowcharts representative of example machine-readable instructions or example operations that may be at least one of executed, instantiated, or performed using an example programmable circuitry implementation of the proxy SPI controller of FIG. 1, according to an embodiment of the present disclosure;

FIG. 22 is a flowchart representative of example machine-readable instructions or example operations that may be at least one of executed, instantiated, or performed using an example programmable circuitry implementation of the proxy SPI peripheral of FIG. 1, according to an embodiment of the present disclosure;

FIG. 23 is a flowchart representative of example machine-readable instructions or example operations that may be at least one of executed, instantiated, or performed using an example programmable circuitry implementation of the proxy SPI controller of FIG. 1, according to an embodiment of the present disclosure.

Corresponding numerals and symbols in different figures generally refer to corresponding parts unless otherwise indicated. The figures are drawn to clearly illustrate relevant aspects of preferred embodiments and are not necessarily drawn to scale.

### DETAILED DESCRIPTION

The making and using of the embodiments disclosed are discussed in detail below. It should be appreciated, however, that the present disclosure provides many applicable inventive concepts that can be embodied in a wide variety of specific contexts. The specific embodiments discussed are merely illustrative of specific ways to make and use the disclosure, and do not limit the scope of the disclosure.

The description below illustrates various specific details to provide an in-depth understanding of several example embodiments according to the description. The embodiments may be received without one or more of the specific details, or with other methods, components, materials and the like. In some cases, known structures, materials or operations are not shown or described in detail so as not to obscure the different aspects of the embodiments. References to “an embodiment” in this description indicate that a particular configuration, structure or feature described in relation to the embodiment is included in at least one embodiment. Consequently, phrases such as “in one embodiment” that may appear at different points of the present description do not necessarily refer exactly to the same embodiment. Furthermore, specific formations, structures or features may be combined in any appropriate manner in one or more embodiments.

Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events.

Embodiments of the present disclosure are described in specific contexts, e.g., an automotive system. Some embodiments may be used in other circuits, such as in flight-based systems, radio sensing systems (e.g., radar, lidar, sonar, etc.), real-time video transmission systems, industrial systems, robotics, drone systems, and/or other systems (e.g., systems designed to support long cable runs).

In an embodiment, protocols are disclosed to facilitate instructions issued by a processor over a first interface (e.g., SPI interface) to be transmitted to a peripheral device over the first interface via a network communicating over a second interface (e.g., SerDes interface, such as an FPD interface). For example, a processor issues a command (e.g., a read command, a write command, a read and write command, etc.) for a peripheral device (e.g., a sensor) to a first component of a network. The first component transmits (e.g., directly or via one or more devices) the command to a second component using a SerDes protocol. The second component translates the command in the SerDes protocol to the SPI protocol and transmits the command to the peripheral device via an SPI interface. Likewise, data from the peripheral device (e.g., a read payload, an acknowledgment, etc.) can be sent over the SPI interface to the second component. The second component can then transmit the data using the SerDes protocol to the first component, which transmits the data to the processor over the SPI interface.

Due to the conversion of the SPI protocol to a SerDes protocol back to an SPI protocol, additional information (e.g., routing path information, type of transfer information, transfer length information, etc.) for such a system. Accordingly, in an embodiment, there are different techniques to communicate the additional information in an SPI/SerDes system.

In some such SPI/SerDes systems, because the processor communicates with the first SerDes component using the SPI protocol that requires a clock of the processor and the second SerDes component communicates with the peripheral device using the SPI protocol that requires a clock of the second SerDes component, differences in the two clocks can result in overflow or underflow of information. Thus, some embodiments include techniques to communicate overflow or underflow of data within the SPI/SerDes system. Some embodiments include techniques to synchronize the clocks or adjust the frequency of one or both of the clocks to avoid underflow or overflow.

Some embodiments support multicast writes and broadcast writes within the SPI/SerDes system. A multicast write corresponds to the processor sending a write command to multiple peripheral devices via the SerDes system. A broadcast write corresponds to a SerDes device that transmits a write command to multiple connected peripheral devices.

In an embodiment, a processor can request to lock a peripheral device in an SPI/SerDes to avoid multiple processors within the SPI/SerDes system from trying to communicate with the sample peripheral device at the same time. A SerDes component within the SerDes network can facilitate the locking and unlocking of a peripheral device to a processor in the SPI/SerDes system.

In an embodiment, acknowledgment protocols are described to facilitate reliable transport for data transfers within the SerDes network.

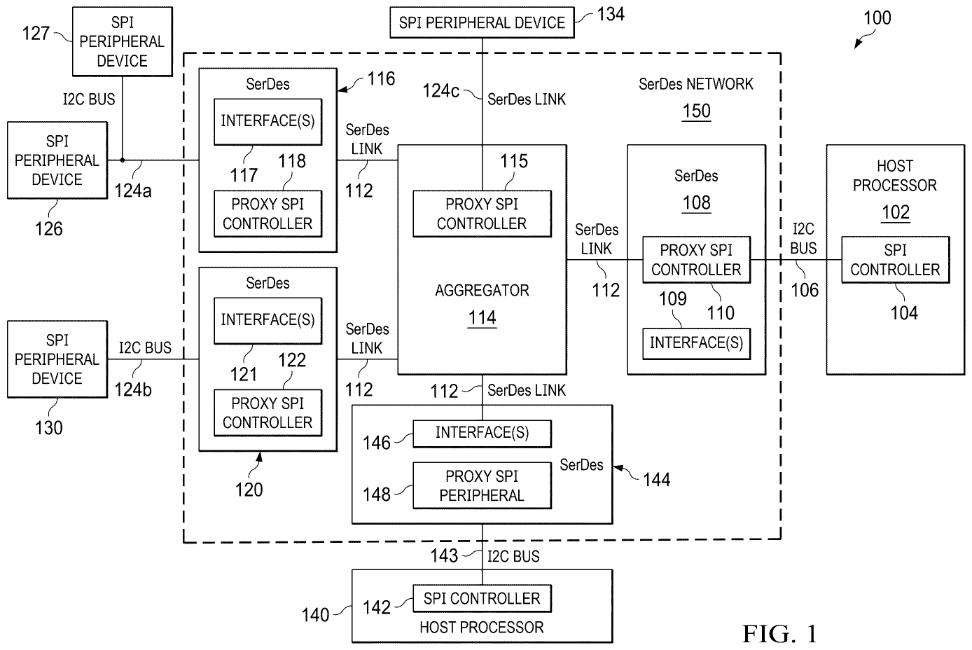

FIG. 1 is a block diagram of a system 100 (also referred to as an SPI/SerDes system), according to an embodiment of the present disclosure. The system 100 includes host processors (or host devices) 102, 140, SPI controllers 104, 142, SPI connections 106, 124a, 124b, 124c 143, SerDes devices 108, 144 (also referred to as processor-side SerDes devices), interface(s) 109, 117, 121, 146, proxy SPI peripherals 110, 148, SerDes connections 112, an aggregator 114 (also referred to as an aggregator device), sensor-side SerDes devices 116, 120, proxy SPI controllers 115, 118, 122, and SPI peripheral devices 126, 127, 130, 134 (also referred to as endpoint devices). FIG. 1 includes a SerDes network 150 that includes the SerDes devices 108, 144, the interface(s) 109, 117, 121, 146, the proxy SPI peripherals 110, 148, the SerDes connections 112, the aggregator 114 (also referred to as an aggregator device), the SerDes devices 116, 120 (also referred to as peripheral device-side SerDes devices), and the proxy SPI controllers 115, 118, 122. Although the system 100 of FIG. 1 includes two single processors, two processor-side SerDes devices, a single aggregator, and two sensor-side SerDes devices, each connected to at least one sensor, the system 100 may include one or more host processors each connected to a processor-side SerDes device, one or more aggregators, and one or more sensor-side SerDes devices, each coupled to one or more sensors (e.g., via a shared SPI connection or separate SPI connections). In some examples, the aggregator 114 may be removed from the system 100. In some such examples, the sensor-side SerDes devices 116, 120 are directly connected to the SerDes device 108 via the SerDes connection 112. Also, any communication sent/received via the SPI connection 106, 124a, 124b, 124c, 143 is done using an SPI protocol, and any communication sent/received via the SerDes connection 112 is done using a SerDes protocol (e.g., using a two-way serial communication protocol such as an SerDes protocol). In some examples, the SPI controller(s) and the SPI target(s) can also be swapped. For example, the host processor 102 may include the proxy SPI controller 118, and the SPI peripheral device 126 may include the SPI controller 104. In some examples, the SPI peripheral devices 126, 127, 130, 134 are sensors/cameras. However, alternative endpoint devices may be used. Other implementations are also possible.

In normal operation, the host processor 102 generates a command (e.g., a read command, a write command, or a read/write command) to be sent to one or more of the SPI peripheral devices 126, 127, 130, 134. The SPI controller 104 outputs the command using a first protocol (e.g., a SPI protocol) via SPI connections 106. One of the interface(s) 109 receives the command using the first protocol via the SPI connections 106. The proxy SPI peripheral 110 converts the command from the first protocol (e.g., SPI protocol) to a second protocol (e.g., a (e.g., two-way) serial communication protocol such as a SerDes protocol, etc.) and one of the interface(s) 109 transmits the command using the second protocol to the intended SPI peripheral device 126, 127, 130, 134 using the SerDes connections 112. For example, the interface 109 can send the command to one or more of the SPI peripheral devices 126, 127, 130, 134 via one or more of the SerDes devices 116, 120, and/or the aggregator 114. In some examples, the SerDes connections 112 may be connections corresponding to a different SerDes protocol. In some embodiments, the SerDes protocol is a wired communication protocol that uses a single wire for data (e.g., full duplex data transmission) and clock signal transmission. In some embodiments, the SPI protocol is a wired communication protocol that uses a first wire for data signals (e.g., half-duplex data transmission) and a second wire for a clock signal.

The proxy SPI controllers 115, 118, 122 may convert the command from the second protocol to the first protocol and send (e.g., using one of the interface(s) 117, 121) the command to a connected SPI peripheral device 126, 127, 130, 134 using the first protocol (e.g., an SPI protocol) via the SPI connection(s) 124a, 124b, 124c. After the intended SPI peripheral device 126, 127, 130, 134 receives the command, the SPI peripheral device(s) 126, 127, 130, 134 responds with an ACK or other data (e.g., read data based on a read command) using the first protocol via the SPI connection(s) 124a, 124b, 124c. In some examples, the ACK/NACK communication is not defined. In such examples, the remote SPI peripherals response is interpreted by the SPI controller 104 based on an agreed protocol between the controller and peripheral. The ACK or other data is transferred back to the host processor(s) 102, 140 through the SerDes device(s) 108, 144 via the SerDes network 150. In this manner, the host processor 102 or 140 can communicate with one or more SPI peripheral devices 126, 127, 130 using the first SPI protocol, and the SerDes network 150 can convert the SPI protocol to the SerDes protocol and facilitate the communication via the SerDes network 150. Also, the host processor 140 and SPI controller 142 can operate in the same manner as the host processor 102 and SPI controller 104. However, the host processor 140 can communicate with the SPI peripheral devices 126, 127, 130, 134 via the SerDes device 144.

In some embodiments, the aggregator 114 aggregates data from the multiple SPI peripheral devices 126, 127, 130, 134 to provide to one or more of the host processors 102, 140 and/or from the multiple host processors 102, 140 to provide to one or more of the SPI peripheral devices 126, 127, 130, 134. In some examples, the aggregator 114 can be used to reduce overall power consumption. In some examples, the aggregator 114 can be omitted, and the SPI peripheral devices 126, 127, 130, 134 can connect to the host processor(s) 102, 140 via the SerDes devices 108, 116, 120, 144.

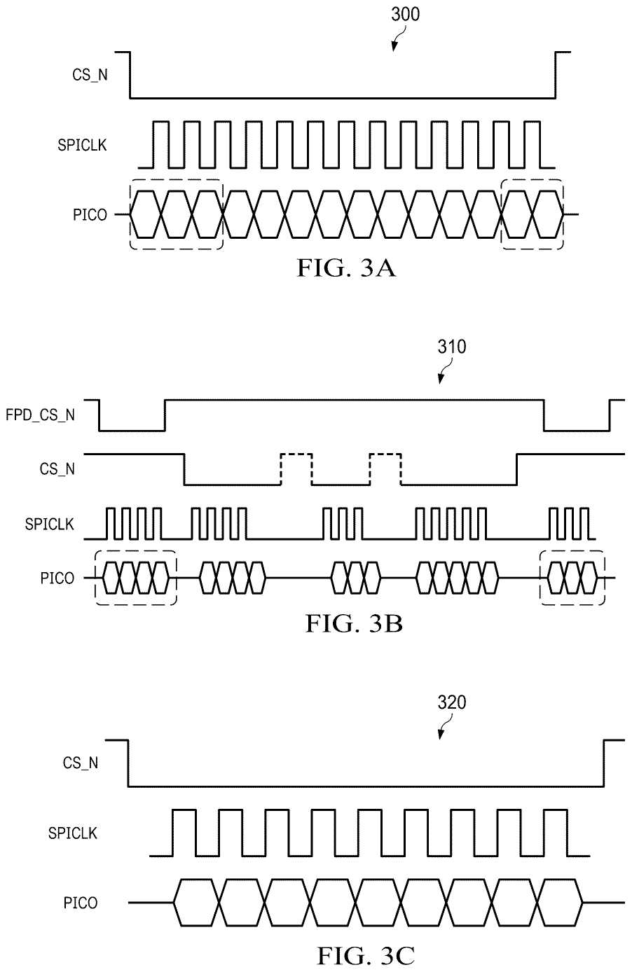

Unlike a point-to-point SPI connection (e.g., without a conversion to a SerDes architecture), the host processor(s) 102, 140 connect(s) to (e.g., multiple) SPI peripheral devices 126, 127, 130, 134 through the SerDes network 150. Accordingly, additional information for the data transfers via the SerDes network 150. The additional information may include SPI peripheral routing information (e.g., an identifier, an address, etc. of an SPI peripheral device), type of data transfer/command (e.g., read, write, read/write, etc.), transfer length, etc. Example implementations for communicating the additional information with respect to the SPI protocol are further described below in conjunction with FIGS. 3A-3C.

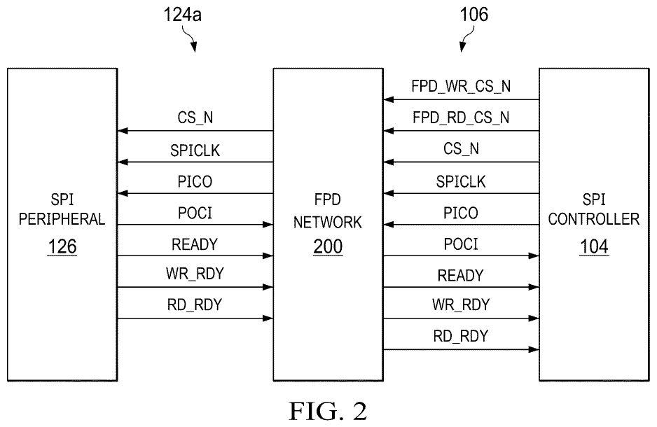

In some embodiments, the SPI connections 106, 124a, 124b, 124c, 143 may include one or more additional pins used to transmit signals that convey flow control. The proxy SPI peripherals 110, 148 and/or the SPI peripheral devices 126, 127, 130, 134 can output a signal on the flow control pins to indicate that the device cannot take more write data or cannot provide more read data (e.g., the local buffer is full and it needs time to process the current data before proceeding). The facilitation of flow control is further illustrated and described, e.g., in FIG. 2.

In some embodiments, the host processor 102 can execute multicast write commands (e.g., when the SPI controller 104 outputs a write command to two or more SPI peripheral devices 126, 127, 130, 134 with the same data (e.g., initial configuration data). In point-to-point topologies (e.g., where SPI devices are connected directly without the SerDes network 150), an SPI controller may need one chip select pin (CS_N) per SPI peripheral device. To minimize the CS_N pin count between the SPI controller 104 and the proxy SPI peripheral 110, the SPI controller 104 can select which two or more SPI peripheral devices 126, 127, 130, 134 to send the write command and output the data signal that identifies the intended SPI peripheral devices 126, 127, 130, 134 for a command based on an identifier and/or an address. In some examples, the SPI controller 104 can transmit the SPI ID/address signal at the beginning of a new SPI transfer to the proxy SPI peripheral 110 within an active CS_N cycle. To understand the topology of the network 100, the SPI controller 104 may store a peripheral list identifying all the SPI peripheral devices 126, 127, 130, 134 within the system 100.

In some embodiments, the sensor-side SerDes device 116 can execute broadcast write commands (e.g., when the proxy SPI controller 118 outputs a write command to two or more connected SPI peripheral devices (e.g., SPI peripheral devices 126, 127) simultaneously. In some examples, broadcast write commands require one CS_N connection for each connected SPI peripheral device 126, 127, so that the connected SPI peripheral devices 126 can determine whether to execute or ignore the write command based on the signal on the CS_N connection. However, other SPI connections, such as SPICLK, PICO, etc., may be shared among all connected SPI peripheral devices. In some examples, to minimize the CS_N connection count, the proxy SPI controller 118 and the multiple remote SPI peripheral devices 126, 127 can share a CS_N pin. In some such examples, the proxy SPI controller 118 may communicate with the remote SPI peripheral devices 126, 127 using a ‘peripheral ID decode’ signal that the SPI peripheral devices 126, 127 can decode to determine whether to execute or ignore a command.

In some embodiments, the host processor 102 may transmit a command to a SPI peripheral device (e.g., the SPI peripheral device 130) via the SerDes network 150 at the same time as the host processor 140 transmits a command to the SPI device 130. To handle a multi-SPI controller scenario, the proxy SPI controllers 115, 118, 122 may support locking of one or more of the SPI peripheral devices 126, 127, 130, 134 to a particular SPI controller 104, 142. For example, when the proxy SPI controller 122 first receives a command from the host processor 102, the proxy SPI controller 122 can lock communication between the host processor 102 and the SPI peripheral device 130. The lock of the SPI peripheral 130 can be maintained across multiple disjoint remote transfers from the same SPI controller 104. While locked, any command received at the proxy SPI controller 122 from any other SPI controller (e.g., the SPI controller 142), the proxy SPI controller 122 declines that command and can transmit a no ACK (NACK) or other indication to the SPI controller 142 to indicate that the SPI peripheral device 130 is locked to another host processor. The proxy SPI controller 122 can remove the lock when a transfer is complete, based on an unlock signal from the host processor 102, and/or based on a duration of time (e.g., automatic unlock after a threshold amount of time occurs with no data transfer).

In some embodiments, the SerDes network 150 can facilitate and/or ensure reliable transport of SPI transfers through the SerDes network 150 using one or more acknowledgment (ACK) protocols. As used herein, end-to-end acknowledgment between SerDes devices includes acknowledgment of reception of data transfers between the last SerDes devices (e.g., the SerDes devices 108, 116, 120, 144) for a data transfer within the SerDes network 150. As used herein, a SerDes link-to-link acknowledgment is an acknowledgment between two neighboring SerDes devices. A SerDes link-to-link acknowledgement can be an ACK handshake at each SerDes hop level. In some embodiments, the SerDes network 150 can utilize end-to-end and/or link-to-link acknowledgment schemes. For example, end-to-end can be used for most data transfers, and link-to-link can be utilized to locate a failure point in the SerDes network 150 for diagnostic purposes. The ACK protocols can be utilized in both directions for write transfers and read transfers. If an ACK handshake fails, there may be N number of retries (e.g., N being limited or unlimited) within the SerDes network 150. In some examples, if the N number of retries are complete without a successful transfer, the corresponding proxy SPI peripheral 110, 148 can inform or interrupt the host processor 102, 140 of the failure to communicate. The N number of retries may be any combination of end-to-end or link-to-link retries or may be two separate thresholds (e.g., one for end-to-end and one for link-to-link).

In some embodiments, because the host SPI controller 104 and the SPI peripheral devices 126, 127, 130, 134 are not directly connected, SPI clocks are driven from two different devices. For example, when communicating data from the host processor 102 to the SPI peripheral device 126, the SPI controller 104 drives a first SPI clock to the proxy SPI peripheral 110, and the proxy SPI controller 118 drives a second SPI clock to the SPI peripheral device 126. SPI clocks driven from two different devices may have a frequency mismatch (e.g., due to device process variations, temperature variations, etc.). The frequency mismatch can adjust over time. Accordingly, one SPI clock may be faster or slower than another SPI clock (e.g., always or at different points in time). Mismatches in SPI clocks can lead to an overflow or underflow of data in buffers within the SerDes network 150. For example, if the SPI controller 104 is transmitting data to the SPI peripheral device 126 faster than the SPI peripheral device 126 can process the data, a buffer within the proxy SPI controller 118 may eventually overflow, leading to packet loss. Accordingly, in some embodiments, the SPI clock of the SPI peripheral devices 126, 127, 130, 134 may be adjusted based on the number of packets in a buffer of a connected proxy SPI controller 115, 118, 122. In some embodiments, an SPI clock synchronization protocols are executed to synchronize the two SPI clocks to avoid under or overflow of buffers within the SerDes network 150.

FIG. 2 illustrates example SPI connections between the SPI controller 104 and the SerDes network 150, and the SerDes network 150 and the SPI peripheral device 126, according to an embodiment of the present disclosure. In the example of FIG. 2, The SerDes network 150 is implemented as an FPD network, the SPI controller 104 is connected to the proxy SPI peripheral 110 of the SerDes network 150 via the SPI connections 106, and the SPI peripheral device 126 is connected to the proxy SPI controller 118 via the SPI connections 124a (e.g., a shared connection for the SPI peripheral devices 126, 127). Although FIG. 2 illustrates an embodiment in which SerDes network 150 interfaces with SPI devices, other types of devices, such as non-SPI devices, may be used.

As shown in FIG. 2, the SPI connections 106, 124a each include a flat panel display write chip select (FPD_WR_CS_N) connection, a flat panel display read chip select (FPD_RD_CS_N) connection, a chip select (CS_N) connection, a SPI clock (SPICLK) connection, a peripheral in controller out PICO connection, a peripheral out controller in (POCI) connection, a READY (or RDY) connection, a write ready (WR_RDY) connection, and a read ready (RD_RDY) connection. Although FIG. 2 includes a plurality of SPI connections, one or more of the connections of FIG. 2 could be omitted and/or combined. Other implementations are also possible.

The FPD_WR_CS_N connection may be used for SPI write transfers through the SerDes network 150 of FIG. 1. The SPI controller 104 can assert (e.g., adjust a signal, such as with an active high level, active low level, active high transition, active low transition or some combination of levels or transitions) the FPD_WR_CS_N connection to indicate that the data on the PICO connection corresponds to the consumption or passing of configuration information (e.g., additional information related to SPI peripheral routing path, type of transfer, transfer length, etc.). The FPD_RD_CS_N connection may be used for SPI read transfers through the SerDes network 150 of FIG. 1. The SPI controller 104 can assert the FPD_RD_CS_N connection to read data from one or more SPI peripheral devices 126, 127, 130, 134.

The SPICLK connection may be used to provide a clock signal to establish timing for sampling the data transfers through the SerDes network 150 of FIG. 1. For example, the SPI controller 104 can transmit a clock signal via the SPICLK connection, and the proxy SPI peripheral 110 can sample data on one or more other connections based on the clock signal. Also, the proxy SPI controller 118 can transmit a clock signal via the SPICLK connection to the SPI peripheral device 126, and the SPI peripheral device 126 can sample data on one or more other connections based on the clock signal. The PICO connection may be used by SPI controller 104 to transmit data (e.g., write data, headers, etc.) to the SPI peripheral device 126 via the SerDes network 150. Thus, the SPI peripheral device 126 receives data (e.g., write data, headers, etc.) on the PICO connection from the SPI controller 104 via the SerDes network 150. The POCI connection may be used by the SPI peripheral device 126 to transmit data (e.g., read data) to the SPI controller 104 via the SerDes network 150. Thus, the SPI controller 104 uses the POCI connection to receive the read data from the SPI controller 104 via the SerDes network 150.

The READY connection (also referred to as a pause connection, a busy connection, etc.) may be used by one or more SerDes devices 116. 108 of the SerDes network 150 and/or the SPI peripheral device 126 to convey back pressure/flow control (e.g., that a buffer is or is about to be full) and/or the availability of the SPI peripheral device 106. For example, if the SPI peripheral device 106 is unavailable or busy, the SPI peripheral device 106 can output an indication on the READY connection that is transmitted to the SPI controller 104 via the SerDes network 150 to indicate that the SPI peripheral device 106 is unavailable or busy. Additionally, if a buffer (e.g., a read buffer) has more than a threshold amount of data stored in it and is full or nearly full, the SerDes device that implements the buffer can output a signal on the READY connection to indicate the backpressure or buffer fullness to the SPI controller 104. When the READY connection indicators backpressure, the SPI controller 104 may stop the SPI clock while keeping the CS_N cycle active or may terminate the CS_N cycle and initiate a new CS_N cycle when the signal on the READY connection indicates no back pressure and/or data availability in the read buffer (of the proxy SPI peripheral 110). In some examples, such as during active cycles, when the SPI controller 104 is writing data into a write buffer of the proxy SPI peripheral 110, the SPI peripheral 110 can output a signal on the READY connection to provide a status of the write buffer occupancy, as further described below. In some examples, the READY connection can be replaced with the WR_RDY and RD_RDY connections. In some such examples, the RD_RDY operates in the same manner as the READY connection for read transfers, and the WR_RDY operates in the same manner as the READY connection for write transfers. For example, the RD_RDY connection can convey backpressure with respect to ready buffers, and the WR_RDY connection can convey backpressure with respect to write buffers.

FIGS. 3A-3B illustrate three ways to provide the additional information when sending a command (e.g., a read transfer, a write transfer, a read and write transfer, etc.), according to an embodiment of the present disclosure. FIG. 3A illustrates a first timing diagram 300 corresponding to the transmission of additional information. FIG. 3B illustrates a second timing diagram 310 corresponding to an alternative transmission of additional information, according to an embodiment of the present disclosure. FIG. 3C illustrates a third timing diagram 320 corresponding to an alternative transmission of additional information, according to an embodiment of the present disclosure.

As described above, the additional information includes information that may be used to transmit commands in a system with at least one SPI controller and one or more SPI peripheral devices connected via an SerDes network. The additional information may include SPI peripheral routing information (e.g., an identifier, an address, etc. of an SPI peripheral device), type of data transfer/command (e.g., read, write, read/write, etc.), transfer length, etc. FIGS. 3A-3C are described with respect to SPI controller 104 being in communication with the SPI peripheral device 126 via the SerDes network 150 of FIG. 3. However, such description may equally apply to any SPI controller and/or any SPI peripheral device.

As shown in the timing diagram 300 of FIG. 3A, one way for the SPI controller 104 to transmit the additional data to the proxy SPI peripheral 110 via the POC connection of the SPI connections 106, in-line along with the write or read data. For example, the SPI controller 104 asserts (e.g., outputs low) a voltage/signal on the CS_N connection of the SPI connections 106 to indicate a data transfer. Also, the SPI controller 104 outputs a clock signal via the SPICLK connection of the SPI connections 106. After the CS_N connection is asserted (e.g., to a logic low) and the SPI clock signal is provided via the SPICLK connection, the SPI controller 104 initiates the data transfer with the additional information on the PICO connection. Although the example of FIG. 3A illustrates the SPI controller 104 outputting the additional information via the POCI connection before the data, the SPI controller 104 may output the additional information via the POCI connection before, during, or after the data.

As shown in the timing diagram 310 of FIG. 3B, another way for the SPI controller 104 to transmit the additional data to proxy SPI peripheral 110 via the PICO connection of the SPI connections 106, in-line along with the write or read data, in conjunction with the FPD_CS_WR_N connection of the SPI connections 106. For example, the SPI controller 104 asserts a voltage/signal on the CS_N connection of the SPI connections 106 to indicate a data transfer and outputs a clock signal via the SPICLK connection of the SPI connections 106. The SPI controller 104 can indicate whether the signal on the PICO connection corresponds to a command or the additional information based on the signal applied to the FPD_WR_CS_N connection. For example, when the SPI controller 104 asserts (e.g., outputs a logic low signal on) the FPD_WR_CS_N connection, the SPI controller 105 also sends additional information on the PICO connection, and when the SPI controller 104 deasserts (e.g., outputs a logic high signal on) the FPD_WR_CS_N connection, the SPI controller 105 also sends the data transfer information on the PICO connection. Because the additional information is used for routing and may not be sent to the SPI peripheral device 126, the SPI controller 105 sends the additional information while the CS_N signal indicates that data transfer is not occurring. In this manner, the SPI peripheral device 126 can ignore the PICO connection during this duration of time.

As shown in the timing diagram 320 of FIG. 3C, another way for the SPI controller 104 to transmit the additional data to proxy SPI peripheral 110 through a control register configuration by any other interface (e.g., an I2C interface) that is included in the SPI connections 106. With the technique of FIG. 3C, the SPI controller 104 writes to the SPI peripheral device 126 in a transparent manner (e.g., SPI operation between the SPI controller 104 and the SPI peripheral device 126 without either device's knowledge of the SerDes network 150).

In some examples, the SPI controller 104 can provide an SPI peripheral ID/address and read/write direction bit to be decoded by one or more components of the SerDes network 150 to route incoming SPI traffic to the intended SPI peripheral device 126. For example, instead of sending the additional information to route a data transfer, the SPI controller 104 can assert all chip selects for every peripheral device within the system 100, along with the SPI peripheral ID and read/write direction bit. In such an example, the SPI peripheral device that matches the ID (or the SerDes device that is connected to the SPI peripheral device that matches the ID) responds with an ACK to establish the path. Such a technique is transparent without requiring the additional information.

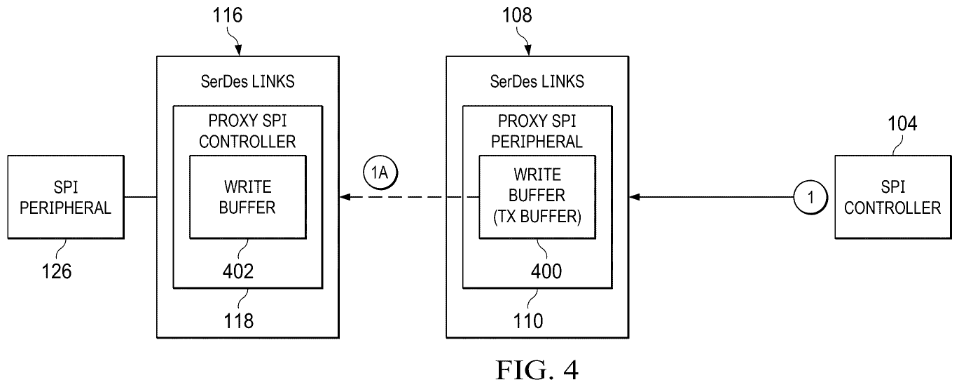

FIG. 4 illustrates a write transfer between the SPI controller 104 and the SPI peripheral device 126 through SerDes network components (e.g., the SerDes device 108 and the SerDes device 116, according to an embodiment of the present disclosure. FIG. 4 includes the SPI controller 104, the SerDes device 108, the proxy SPI peripheral 110, the SerDes device 116, the proxy SPI controller 118, and the SPI peripheral device 126 of FIG. 1. The proxy SPI peripheral 110 includes a write buffer 400 (also referred to as a TX buffer), and the proxy SPI controller 118 includes a write buffer 402 (also referred to as a TX buffer). Although FIG. 4 is described in conjunction with the SPI controller 104 and the SPI peripheral device 126, FIG. 4 may be described in conjunction with any SPI controller and any SPI peripheral device. For example, FIG. 4 may be described in conjunction with a write transfer between the SPI controller 142 and the SPI peripheral device 126, 127, 130, or 134 of FIG. 1. Other implementations are also possible.

In normal operation, the SPI controller 104 outputs a configuration write for the SPI peripheral device 126 through the SerDes device 108 using the SPI protocol described above. After the proxy SPI peripheral 110 of the SerDes device 108 receives the configuration write command (e.g., via the interface(s) 109 of FIG. 1), the proxy SPI peripheral 110 stores the configuration write command in the buffer 400. When the proxy SPI peripheral 110 is ready (e.g., it may be performing another task when the command was received), the proxy SPI peripheral 110 accesses the configuration write command from the buffer 400 and transmits (e.g., using the interface(s) 109) the configuration write command to the SerDes device 116 connected to the SPI peripheral device 126 using an SerDes link protocol. After the proxy SPI controller 118 of the SerDes device 116 receives the configuration write command (e.g., via the interface(s) 117 of FIG. 1), the proxy SPI controller 118 stores the configuration write command in the buffer 402. After the proxy SPI controller 118 is ready (e.g., it may be performing another task when the command was received), the proxy SPI controller 118 accesses the configuration write command from the buffer 402 and transmits (e.g., using the interface(s) 117) the configuration write command to the SPI peripheral device 126 using the SPI link protocol described above. After the SPI peripheral device 126 receives the configuration write command, the SPI peripheral device 126 performs the write command.

As described above, if, during operation, the amount of data within either buffer 400, 402 is more than a threshold (e.g., corresponding to a potential overflow), the SerDes device 108, 116 with the corresponding buffer 400, 402 can indicate the potential overflow with a buffer fullness indication to the SPI controller 104, as further illustrated and described, e.g., FIG. 2. In some examples, if, during operation, the amount of data within either buffer 400, 402 is more than a first threshold (e.g., corresponding to a potential overflow) or below a second threshold (e.g., corresponding to a potential underflow), a protocol can be performed to sync or adjust clock signals of the SPI controller 104 and/or the proxy SPI controller 118, as further illustrated and described, e.g., FIG. 1. In some embodiments, the SPI write transfer is a one-step process from the point of view of the SPI controller 104.

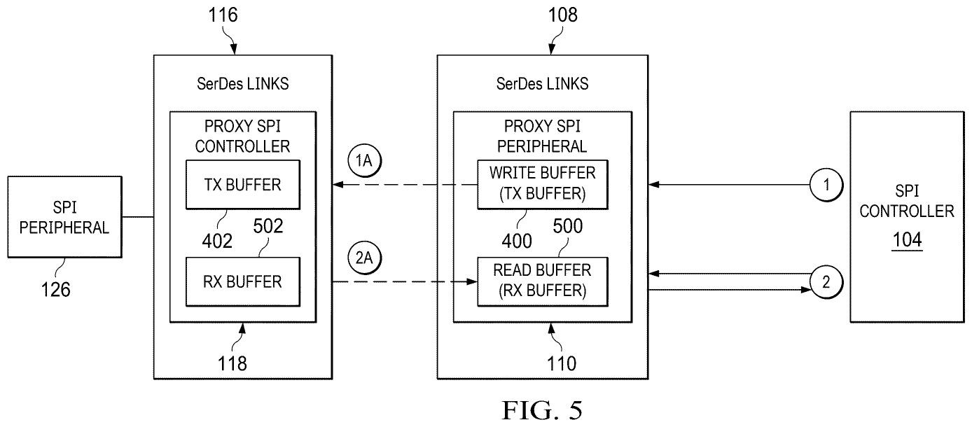

FIG. 5 illustrates a read transfer between the SPI controller 104 and the SPI peripheral device 126 through SerDes network components (e.g., the SerDes device 108 and the SerDes device 116), according to an embodiment of the present disclosure. FIG. 5 includes the SPI controller 104, the SerDes device 108, the proxy SPI peripheral 110, the SerDes device 116, the proxy SPI controller 118, and the SPI peripheral device 126 of FIG. 1. The proxy SPI peripheral 110 includes the write buffer 400 (also referred to as a TX buffer) of FIG. 4 and a read buffer 500 (also referred to as a RX buffer), and the proxy SPI controller 118 includes the write buffer 402 (also referred to as a TX buffer) of FIG. 4 and a read buffer 502 (also referred to as a RX buffer). Although FIG. 5 is described in conjunction with the SPI controller 104 and the SPI peripheral device 126, FIG. 5 may be described in conjunction with any SPI controller and any SPI peripheral device. For example, FIG. 5 may be described in conjunction with a read transfer between the SPI controller 142 and the SPI peripheral device 126, 127, 130, or 134 of FIG. 1. Other implementations are also possible.

In normal operation, the SPI controller 104 outputs a configuration write for the SPI peripheral device 126 through the SerDes device 108 using the SPI protocol described above. The configuration write may include an address or other instructions for the SPI peripheral device 126 (e.g., based on a controller-peripheral protocol). After the Proxy SPI peripheral 110 of the SerDes device 108 receives the configuration write command (e.g., via the interface(s) 109 of FIG. 1), the proxy SPI peripheral 110 stores the configuration write command in the buffer 400. When the proxy SPI peripheral 110 is ready (e.g., it may be performing another task when the command was received), the proxy SPI peripheral 110 accesses the configuration write command from the buffer 400 and transmits (e.g., using the interface(s) 109) the configuration write command to the SerDes device 116 connected to the SPI peripheral device 126 using an SerDes link protocol. After the proxy SPI controller 118 of the SerDes device 116 receives the configuration write command (e.g., via the interface(s) 117 of FIG. 1), the proxy SPI controller 118 stores the configuration write command in the buffer 402. When the proxy SPI controller 118 is ready (e.g., not currently performing another task), the proxy SPI controller 118 accesses the configuration write command from the buffer 402 and transmits (e.g., using the interface(s) 117) the configuration write command to the SPI peripheral device 126 using the SPI link protocol described above. After the SPI peripheral device 126 receives the configuration write command, the SPI peripheral device 126 performs the read command to obtain the corresponding read data and transmit the read data to the SerDes device 116 using the SPI protocol described above.

After the SerDes device 116 receives the read data (via the interface 117), the proxy SPI controller 118 stores the read data in the read buffer 502. When the proxy SPI controller 118 is ready, the proxy SPI controller 118 accesses the read data from the buffer 502 and transmits (e.g., using the interface(s) 117) the read data to the SerDes device 108 using the SerDes protocol. After the SerDes device 108 receives the read data (e.g., using the interface(s) 109), the proxy SPI peripheral 110 of the SerDes device 108 stores the read data in the read buffer 500. When the proxy SPI peripheral 110 is ready, the proxy SPI peripheral 110 accesses the read data in the buffer 500 and transmits the read data to the SPI controller 104 (e.g., via the interface(s) 109) using the SPI protocol described above.

As described above, if, during operation, the amount of data within either buffer 400, 402, 500, 502 is more than a threshold (e.g., corresponding to a potential overflow), the SerDes device 108, 116 with the corresponding buffer 400, 402, 500, 502 can indicate the potential overflow to the SPI controller 104 with a buffer fullness indication, as further illustrated and described, e.g., FIG. 2. In some examples, if, during operation, the amount of data within either buffer 400, 402, 500, 502 is more than a first threshold (e.g., corresponding to a potential overflow) or below a second threshold (e.g., corresponding to a potential underflow), a protocol can be performed to sync or adjust clock signals of the SPI controller 104 and/or the proxy SPI controller 118, as further illustrated and described, e.g., FIG. 1. The SPI write transfer is a two-step process from the point of view of the SPI controller 104.

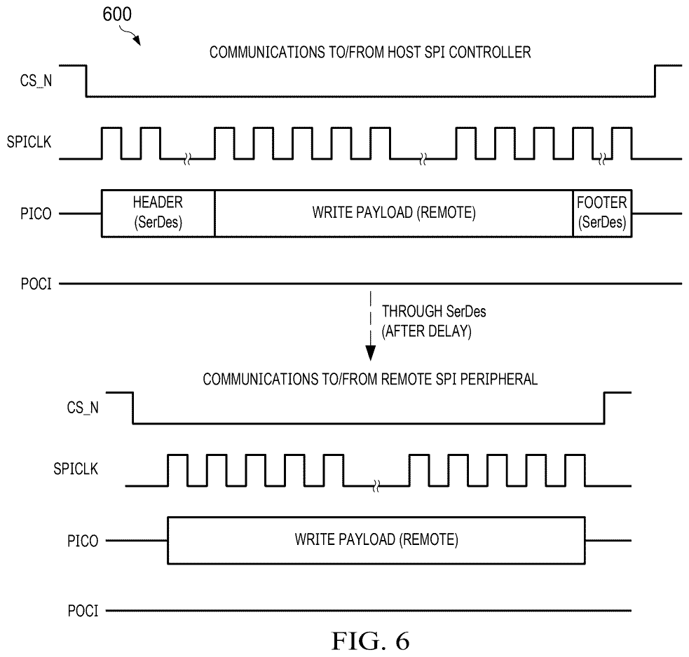

FIG. 6 illustrates a timing diagram 600 that illustrates SPI communications for a write command from the SPI controller 104 to the SPI peripheral device 126 through the SerDes network 150 of FIG. 1, according to an embodiment of the present disclosure. FIG. 6 is described in conjunction with including the additional information in the header (also referred to as a prefix), as further illustrated and described, e.g., FIG. 3A. However, FIG. 6 could be described in conjunction with any technique for providing the additional information, as further described above. Also, although FIG. 6 is described in conjunction with the CS_N, SPICLK, PICO, and POCI connections of the SPI connections 106, 124a, additional or alternative connections may be used, as further illustrated and described, e.g., FIG. 2. Although FIG. 6 is described in conjunction with the SPI controller 104 and the SPI peripheral device 126, FIG. 6 may be described in conjunction with any SPI controller and any SPI peripheral device. For example, FIG. 6 may be described in conjunction with a write command between the SPI controller 142 and the SPI peripheral device 126, 127, 130, or 134 of FIG. 1. Other implementations are also possible.

As shown in the timing diagram 600, the SPI controller 104 initiates a write command by asserting a signal on the CS_N connection (e.g., adjusting the signal on the CS_N connection from a logic high to a logic low) and transmitting a clock signal on the SPICLK connection. Alternatively, the CS_N signal may correspond to an active high protocol, where the signal on the CS_N connection is a high signal when the SPI controller 104 initiates a command. As described above, the signal on the CS_N connection adjusting to a logic low signal informs the SerDes device 108 that data transfer is occurring. Additionally, the SerDes device 108 samples the data on the PICO connection based on the clock signal (e.g., at a rising edge and/or falling edge of the clock signal) asserted on the SPICLK connection.

While the CS_N signal is asserted on the CS_N connection and the clock signal is sent on the SPICLK connection, the SPI controller 104 outputs a header, followed by a write payload and a footer (also referred to as a suffix) on the PICO connection. The header may include additional information, such as routing information (e.g., an address of the target SPI peripheral device), the type of data transfer (e.g., read/write, remote/local, etc.), a length (e.g., the number of bytes of data to be transferred), etc. Remote/local information corresponds to whether the host SPI controller 104 is intended to access (e.g., register write/read) via an immediate connection (e.g., local) or via another component (e.g., non-local or remote). As described above, the header may not be included. Rather, the additional information may be provided by a different technique described above. The write payload may include the write command information (e.g., what information to write, where to write it, etc.). The footer may include cyclic redundancy check (CRC) bits, forward error correction (FEC) bits, error correction code (ECC) bits, and/or any other data protection information, dummy bytes replacing CRC/FEC/ECC, etc. In some examples, the footer may not be included.

As described above, the SerDes network 150 receives the write payload and corresponding information sent via the SPI protocol, converts the information into an SerDes protocol, and transmits the information to the SerDes device 116 that is connected to the target SPI peripheral device 126 using the SerDes protocol. The proxy SPI controller 118 of the SerDes device 116 sends (e.g., via the interface(s) 117) the write payload to the SPI peripheral device 126 using the SPI protocol. For example, the proxy SPI controller 118 transmits the write payload by asserting a signal on the CS_N connection (e.g., adjusting the signal on the CS_N connection from a logic high to a logic low) and transmitting a clock signal on the SPICLK connection. Alternatively, the CS_N signal may correspond to an active high protocol, where the signal on the CS_N connection is a high signal when the proxy SPI controller 118 initiates a data transfer. As described above, the signal on the CS_N connection adjusting to a logic low signal informs the SPI peripheral device 126 that data transfer is occurring. Additionally, the SPI peripheral device 126 samples the data on the PICO connection based on the clock signal (e.g., at a rising edge and/or falling edge of the clock signal). While the CS_N signal is asserted on the CS_N connection and the clock signal is sent on the SPICLK connection, the proxy SPI controller 118 transmits the write payload to the SPI peripheral device 126 via the PICO connection. The SPI peripheral device 126 processes the write payload to execute the write command.

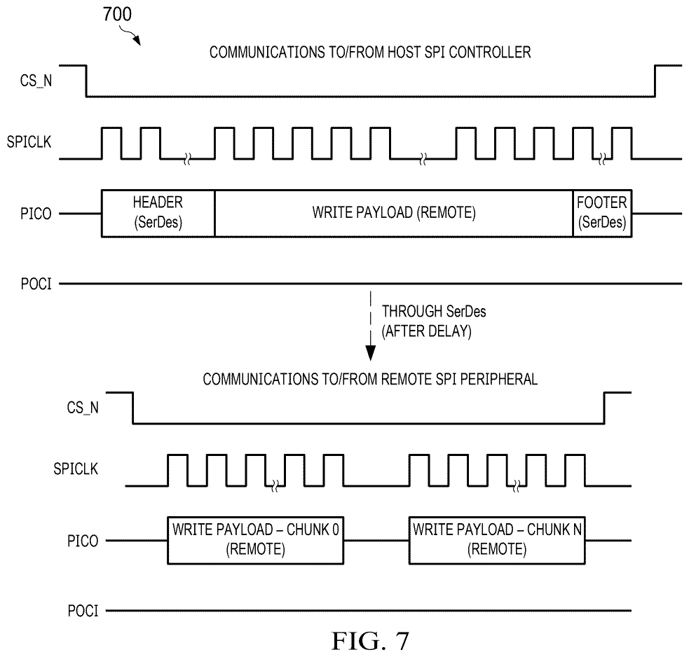

FIG. 7 illustrates a timing diagram 700 that illustrates SPI communications for a write command from the SPI controller 104 to the SPI peripheral device 126 through the SerDes network 150 of FIG. 1, where the write payload arrives in multiple chunks or portions (e.g., for larger payloads, according to an embodiment of the present disclosure. For example, the payload may be broken into N chunks/portions. FIG. 7 is described in conjunction with including the additional information in the header, as further illustrated and described, e.g., FIG. 3A. However, FIG. 7 could be described in conjunction with any technique for providing the additional information, as further described above. Also, although FIG. 7 is described in conjunction with the CS_N, SPICLK, PICO, and POCI connections of the SPI connections 106, 124a, additional or alternative connections may be used, as further illustrated and described, e.g., FIG. 2. Although FIG. 7 is described in conjunction with the SPI controller 104 and the SPI peripheral device 126, FIG. 7 may be described in conjunction with any SPI controller and any SPI peripheral device. For example, FIG. 7 may be described in conjunction with a write command between the SPI controller 142 and the SPI peripheral device 126, 127, 130, or 134 of FIG. 1. Other implementations are also possible.

As shown in the timing diagram 700, the SPI controller 104 initiates a write command by asserting a signal on the CS_N connection (e.g., adjusting the signal on the CS_N connection from a logic high to a logic low) and transmitting a clock signal on the SPICLK connection. Alternatively, the CS_N signal may correspond to an active high protocol, where the CS_N signal is a high signal when the SPI controller 104 initiates a command. As described above, the CS_N signal adjusting to a logic low signal informs the SerDes device 108 that data transfer is occurring. Additionally, the SerDes device 108 samples the data on the PICO connection based on the clock signal (e.g., at a rising edge and/or falling edge of the clock signal).

While the CS_N signal is asserted on the CS_N connection and the clock signal is sent on the SPICLK connection, the SPI controller 104 outputs a header, followed by a write payload and a footer on the PICO connection. The header may include additional information, such as routing information (e.g., an address of the target SPI peripheral device), the type of data transfer (e.g., read/write, remote/local, etc.), a length (e.g., the number of bytes of data to be transferred), etc. As described above, the header may not be included. Rather, the additional information may be provided by a different technique described above. The write payload may include the write command information (e.g., what information to write, where to write it, etc.). The footer may include cyclic redundancy check (CRC) bits, forward error correction (FEC) bits, error correction code (ECC) bits, and/or any other data protection information, dummy bytes replacing CRC/FEC/ECC, etc. In some examples, the footer may not be included.

As described above, the SerDes network 150 receives the write payload and corresponding information sent via the SPI protocol, converts the information into an SerDes protocol, and transmits the information to the SerDes device 116 that is connected to the target SPI peripheral device 126 using the SerDes protocol. If the payload is large, the proxy SPI peripheral 110 or the proxy SPI controller 118 of the SerDes network 150 may break the payload into multiple smaller chunks/portions. The proxy SPI controller 118 of the SerDes device 116 sends (e.g., via the interface(s) 117) the N write payload portions (0-N) to the SPI peripheral device 126 using the SPI protocol. For example, the proxy SPI controller 118 transmits the first chunk/portion of the write payload by asserting a signal on the CS_N connection (e.g., adjusting the signal on the CS_N connection from a logic high to a logic low) and transmitting a clock signal on the SPICLK connection. Alternatively, the CS_N signal may correspond to an active high protocol, where the CS_N signal is a high signal when the proxy SPI controller 118 initiates a data transfer. As described above, the CS_N signal adjusting to a logic low signal informs the SPI peripheral device 126 that data transfer is occurring. Additionally, the SPI peripheral device 126 samples the first chunk/portion of the write payload on the PICO connection based on the clock signal (e.g., at a rising edge and/or falling edge of the clock signal). While the CS_N signal is asserted on the CS_N connection and the clock signal is sent on the SPICLK connection, the proxy SPI controller 118 transmits the first portion/chunk of the write payload to the SPI peripheral device 126 via the PICO connection. While waiting for the second chunk/portion of the payload, the proxy SPI controller 118 stops the clock signal on the SPI clock. Because the SPI peripheral device 126 samples the data on the PICO connection based on the clock signal, if there is no clock signal, the SPI peripheral device 126 pauses sampling until the clock signal restarts. After the proxy SPI controller 118 receives and/or generates the subsequent chunk/portion of the payload, the proxy SPI controller 118 restarts the clock signal on the SPICLK connection and transmits the subsequent chunk/portion of the payload. During this process, the proxy SPI controller 118 maintains assertion of the CS_N connection so that the SPI peripheral device can obtain and process the multiple chunks as a single payload. The SPI peripheral device 126 processes the write payload to execute the write command.

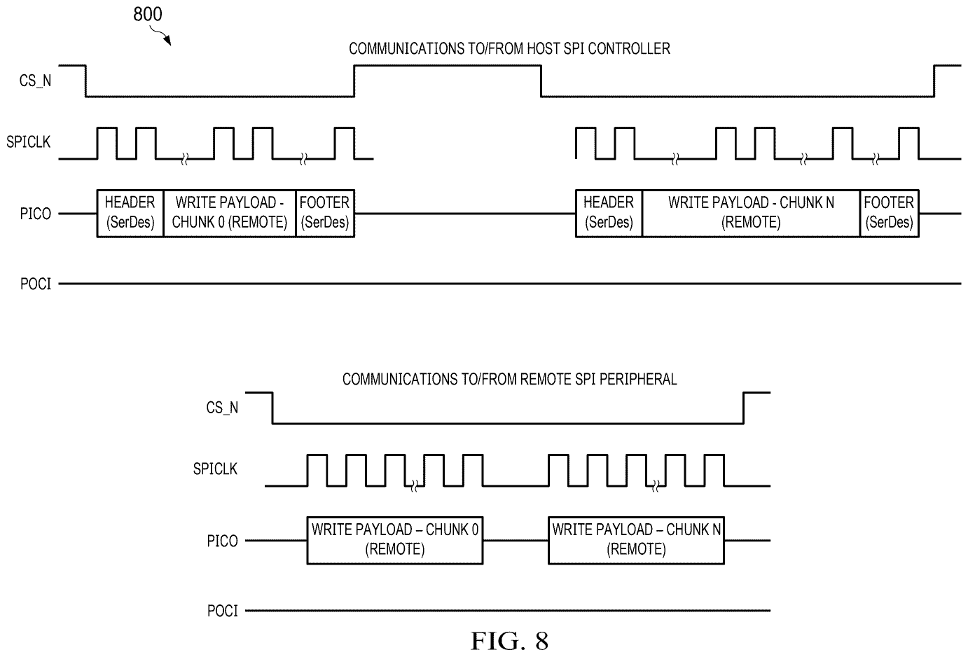

FIG. 8 illustrates a timing diagram 800 that illustrates SPI communications for a write command from the SPI controller 104 to the SPI peripheral device 126 through the SerDes network 150 of FIG. 1, where the SPI controller 104 breaks the write payload into multiple chunks or portions (e.g., throttling for larger payloads based on time), according to an embodiment of the present disclosure. For example, the payload may be broken into N chunks/portions. FIG. 8 is described in conjunction with including the additional information in the header, as further illustrated and described, e.g., FIG. 3A. However, FIG. 8 could be described in conjunction with any technique for providing the additional information, as further described above. Also, although FIG. 8 is described in conjunction with the CS_N, SPICLK, PICO, and POCI connections of the SPI connections 106, 124a, additional or alternative connections may be used, as further illustrated and described, e.g., FIG. 2. Although FIG. 8 is described in conjunction with the SPI controller 104 and the SPI peripheral device 126, FIG. 8 may be described in conjunction with any SPI controller and any SPI peripheral device. For example, FIG. 8 may be described in conjunction with a write command between the SPI controller 142 and the SPI peripheral device 126, 127, 130, or 134 of FIG. 1. Other implementations are also possible.

If a write payload is large, the SPI controller 104 may break the write payload into multiple smaller write payload chunks/portions and send out each portion separately. As shown in the timing diagram 800 of FIG. 8, the SPI controller 104 initiates a write command by asserting a signal on the CS_N connection (e.g., adjusting the signal on the CS_N connection from a logic high to a logic low) and transmitting a clock signal on the SPICLK connection. Alternatively, the CS_N signal may correspond to an active high protocol, where the CS_N signal is a high signal when the SPI controller 104 initiates a command. As described above, the CS_N signal adjusting to a logic low signal informs the SerDes device 108 that data transfer is occurring. Additionally, the SerDes device 108 samples the data on the PICO connection based on the clock signal (e.g., at a rising edge and/or falling edge of the clock signal).

While the CS_N signal is asserted on the CS_N connection and the clock signal is sent on the SPICLK connection, the SPI controller 104 outputs a header, followed by a first write payload chunk/portion and a footer on the PICO connection. The header may include additional information, such as routing information (e.g., an address of the target SPI peripheral device), the type of data transfer (e.g., read/write, remote/local, etc.), a length (e.g., the number of bytes of data to be transferred), etc. As described above, the header may not be included. Rather, the additional information may be provided by a different technique described above. The write payload chunk/portion may include a first portion /hunk of write command information (e.g., what information to write, where to write it, etc.). The footer may include cyclic redundancy check (CRC) bits, forward error correction (FEC) bits, error correction code (ECC) bits, and/or any other data protection information, dummy bytes replacing CRC/FEC/ECC, etc. In some examples, the footer may not be included. After the SPI controller 104 transmits the first chunk/portion via the PICO connection, the SPI controller 104 toggles the signal on the CS_N connection and pauses the clock signal on the SPICLK connection and reasserts the signal on the CS_N connection and the clock signal on the SPICLK connection for the second payload chunk/portion corresponding to the write payload.

The SerDes network 150 receives the write payload chunks/portions and corresponding information sent via the SPI protocol, converts the information into an SerDes protocol, and transmits the information to the SerDes device 116 that is connected to the target SPI peripheral device 126 using the SerDes protocol. The proxy SPI controller 118 of the SerDes device 116 sends (e.g., via the interface(s) 117) the N write payload portions (0-N) to the SPI peripheral device 126 using the SPI protocol. For example, the proxy SPI controller 118 transmits the first chunk/portion of the write payload by asserting a signal on the CS_N connection (e.g., adjusting the signal on the CS_N connection from a logic high to a logic low) and transmitting a clock signal on the SPICLK connection. Alternatively, the CS_N signal may correspond to an active high protocol, where the CS_N signal is a high signal when the proxy SPI controller 118 initiates a data transfer. As described above, the CS_N signal adjusting to a logic low signal informs the SPI peripheral device 126 that data transfer is occurring. Additionally, the SPI peripheral device 126 samples the first chunk/portion of the write payload on the PICO connection based on the clock signal (e.g., at a rising edge and/or falling edge of the clock signal). While the CS_N signal is asserted on the CS_N connection and the clock signal is sent on the SPICLK connection, the proxy SPI controller 118 transmits the first portion/chunk of the write payload to the SPI peripheral device 126 via the PICO connection. While waiting for the second chunk/portion of the payload, the proxy SPI controller 118 stops the clock signal on the SPI clock. Because the SPI peripheral device 126 samples the data on the PICO connection based on the clock signal, if there is no clock signal, the SPI peripheral device 126 pauses sampling until the clock signal restarts. After the proxy SPI controller 118 receives and/or generates the subsequent chunk/portion of the payload, the proxy SPI controller 118 restarts the clock signal on the SPICLK connection and transmits the subsequent chunk/portion of the payload. During this process, the proxy SPI controller 118 maintains assertion of the CS_N connection so that the SPI peripheral device can obtain and process the multiple chunks as a single payload. The SPI peripheral device 126 processes the write payload to execute the write command.

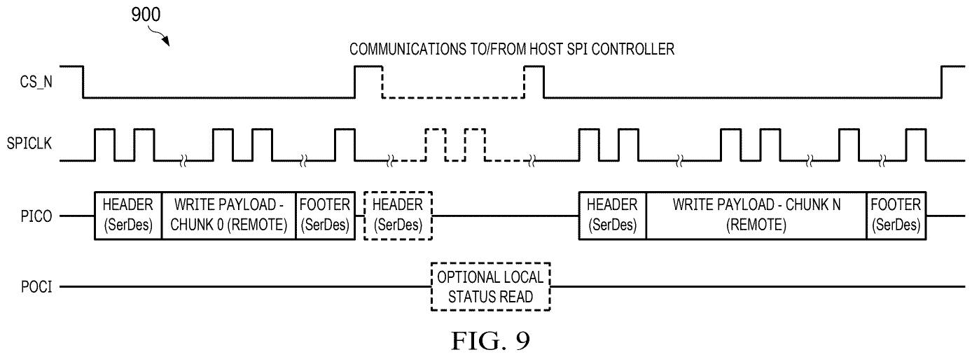

FIG. 9 illustrates a timing diagram 900 that illustrates SPI communications for a write command from the SPI controller 104 to the SPI peripheral device 126 through the SerDes network 150 of FIG. 1, where the SPI controller 104 breaks the write payload into multiple chunks or portions (e.g., throttling for larger payloads based on time), according to an embodiment of the present disclosure. For example, the payload may be broken into N chunks/portions. FIG. 9 is described in conjunction with including the additional information in the header, as further illustrated and described, e.g., FIG. 3A. However, FIG. 9 could be described in conjunction with any technique for providing the additional information, as further described above. Also, although FIG. 9 is described in conjunction with the CS_N, SPICLK, PICO, and POCI connections of the SPI connections 106, additional or alternative connections may be used, as further illustrated and described, e.g., FIG. 2. Although FIG. 9 is described in conjunction with the SPI controller 104 and the SPI peripheral device 126, FIG. 9 may be described in conjunction with any SPI controller and any SPI peripheral device. For example, FIG. 9 may be described in conjunction with a write command between the SPI controller 142 and the SPI peripheral device 126, 127, 130, or 134 of FIG. 1. Other implementations are also possible.

In the timing diagram 900, the SPI controller 104 operates in a similar manner to the timing diagram 800 of FIG. 8. However, instead of toggling the CS_N assertion on and off between chucks of a wire payload, the SPI controller 104, after the SPI controller 104 transmits each write payload chunk/portion, the SPI controller 104 polls the local status register to verify that the transmit buffer 400 of the SerDes device 108 of FIG. 4 is not overloaded. For example, the SPI controller 104 outputs a header on the PICO connection to instruct the SerDes device 108 to provide a status of the buffer 400. Then, the SPI controller 104 receives the status via the POCI connection. If the status corresponds to the buffer 400 of the SerDes device 108 being overloaded, the SPI controller 104 can wait for a duration of time and/or resend a buffer status request. If the status corresponds to the buffer 400 not being overloaded, the SPI controller 104 executes the SPI protocol for a subsequent write payload chunk/portion.

Additionally or alternatively, the SPI controller 104 can toggle the signal on the CS_N connection and poll a GPIO pin or wait for a dedicated flow control pin-based signaling to determine that the buffer 400 of the SerDes device 108 is not overloaded before sending a subsequent write payload chunk/portion. Additionally or alternatively, the SPI controller 104 can wait for a fixed delay or threshold amount of time before sending a subsequent write payload chunk/portion and rely on the SerDes device 108 to assert an interrupt when the buffer 400 is overloaded.

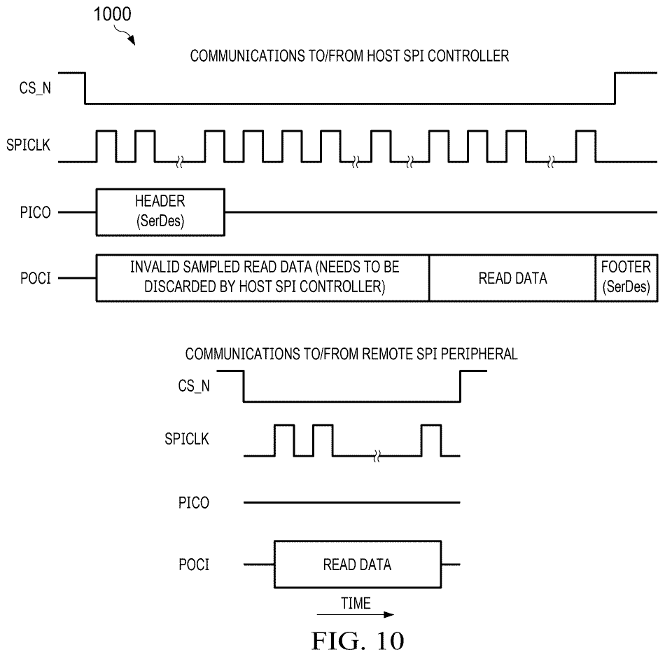

FIG. 10 illustrates a timing diagram 1000 that illustrates SPI communications for a read command from the SPI controller 104 to the SPI peripheral device 126 through the SerDes network 150 of FIG. 1, according to an embodiment of the present disclosure. FIG. 10 is described in conjunction with including the additional information in the header, as further illustrated and described, e.g., FIG. 3A. However, FIG. 10 could be described in conjunction with any technique for providing the additional information, as further described above. Also, although FIG. 10 is described in conjunction with the CS_N, SPICLK, PICO, and POCI connections of the SPI connections 106, 124a, additional or alternative connections may be used, as further illustrated and described, e.g., FIG. 2. Although FIG. 10 is described in conjunction with the SPI controller 104 and the SPI peripheral device 126, FIG. 10 may be described in conjunction with any SPI controller and any SPI peripheral device. For example, FIG. 10 may be described in conjunction with a read command between the SPI controller 142 and the SPI peripheral device 126, 127, 130, or 134 of FIG. 1. Other implementations are also possible.

As shown in the timing diagram 1000, the SPI controller 104 initiates a read command by asserting a signal on the CS_N connection (e.g., adjusting the signal on the CS_N connection from a logic high to a logic low) and transmitting a clock signal on the SPICLK connection. Alternatively, the CS_N signal may correspond to an active high protocol, where the CS_N signal is a high signal when the SPI controller 104 initiates a command. As described above, the CS_N signal adjusting to a logic low signal informs the SerDes device 108 that data transfer is occurring. Additionally, the SerDes device 108 samples the data on the PICO connection based on the clock signal (e.g., at a rising edge and/or falling edge of the clock signal).

While the CS_N signal is asserted on the CS_N connection and the clock signal is sent on the SPICLK connection, the SPI controller 104 outputs a header. The header may include additional information, such as routing information (e.g., an address of the target SPI peripheral device), the type of data transfer (e.g., read/write, remote/local, etc.), a length (e.g., the number of bytes of data to be transferred), etc. As described above, the header may not be included. Rather, the additional information may be provided by a different technique described above.

As described above, the SerDes network 150 receives the header sent via the SPI protocol and uses the information in the header to forward a request to the SerDes device 116 that is connected to the target SPI peripheral device 126 using the SerDes protocol. The proxy SPI controller 118 of the SerDes device 116 receives (e.g., via the interface(s) 117) the read request from the SPI peripheral device 126 using the SPI protocol. For example, the proxy SPI controller 118 receives the read payload by asserting a signal on the CS_N connection (e.g., adjusting the signal on the CS_N connection from a logic high to a logic low) and transmitting a clock signal on the SPICLK connection. Alternatively, the CS_N signal may correspond to an active high protocol, where the CS_N signal is a high signal when the proxy SPI controller 118 initiates a data transfer. As described above, the CS_N signal adjusting to a logic low signal informs the SPI peripheral device 126 that data transfer is occurring. Additionally, the SPI peripheral device 126 samples the data on the POCI connection based on the clock signal (e.g., at a rising edge and/or falling edge of the clock signal). While the CS_N signal is asserted on the CS_N connection and the clock signal is sent on the SPICLK connection, the proxy SPI controller 118 transmits a read request to the SPI peripheral device 126 via the PICO connection and receives the read data from the SPI peripheral device 126 via the POCI connection. The SPI peripheral device 126 transmits the read data based on the clock signal received via the SPICLK connection.

The proxy SPI controller 118 samples the read data on the POCI connection and transmits (e.g., using the interface(s) 117) the read data using the SerDes protocol to the proxy SPI peripheral 110 of the SerDes network 150. The proxy SPI peripheral 110 forwards the read data (e.g., using the interface(s) 109) based on the clock signal on the SPICLK connection of the SPI connections 106. The read data and a footer are transmitted via the POCI connection of the SPI connections 106 so that the SPI controller 104 can sample the read data using the SPI protocol. The SPI controller 104 discards the initial sampled read data because the initial data on the POCI connection is invalid. The number of bytes before the valid read data is received via the POCI connection is known. Thus, the SPI controller 104 discards a known number of invalid bytes received via the POCI connection until the valid read data is received. In some examples, the number of invalid bytes is based on a configurable maximum SerDes delay.

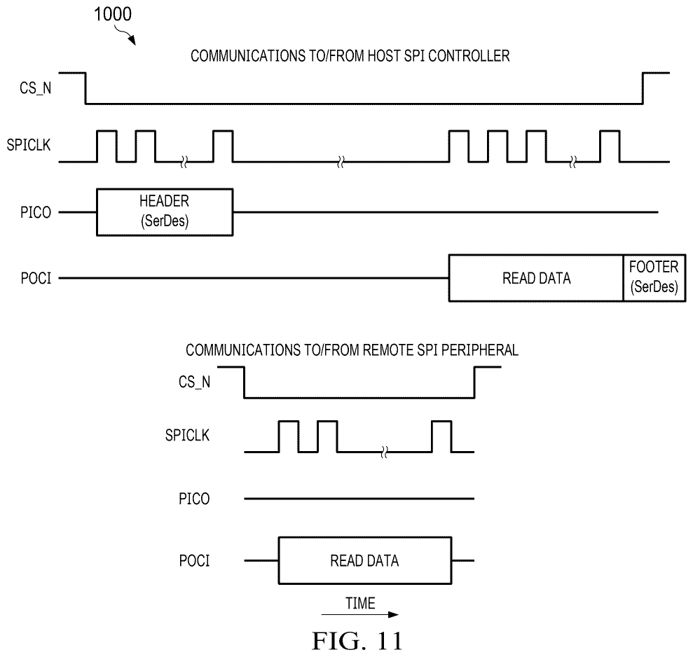

FIG. 11 illustrates a timing diagram 1100 that illustrates SPI communications for a read command from the SPI controller 104 to the SPI peripheral device 126 through the SerDes network 150 of FIG. 1, according to an embodiment of the present disclosure. FIG. 11 is described in conjunction with including the additional information in the header, as further illustrated and described, e.g., FIG. 3A. However, FIG. 10 could be described in conjunction with any technique for providing the additional information, as further described above. Also, although FIG. 11 is described in conjunction with the CS_N, SPICLK, PICO, and POCI connections of the SPI connections 106, 124a, additional or alternative connections may be used, as further illustrated and described, e.g., FIG. 2. Although FIG. 11 is described in conjunction with the SPI controller 104 and the SPI peripheral device 126, FIG. 11 may be described in conjunction with any SPI controller and any SPI peripheral device. For example, FIG. 11 may be described in conjunction with a read command between the SPI controller 142 and the SPI peripheral device 126, 127, 130, or 134 of FIG. 1. Other implementations are also possible.

The protocol corresponding to the timing diagram 1100 is similar to the protocol of the timing diagram 1000 of FIG. 10. However, instead of the SPI controller 104 discarding invalid data for a known duration of time before the read data is provided on the POCI connection, the SPI controller 104 stops the clock signal on the SPICLK connection for a duration of time corresponding to the time for the read data to be provided on the POCI connection (e.g., based on a configurable max SerDes delay). In this manner, because there is no clock on the SPICLK connection, the proxy SPI peripheral 110 does not transmit invalid data, and when the clock is reinitiated on the SPICLK connection, the proxy SPI peripheral 110 provides the read data and a footer from the SPI peripheral device 126 to the SPI controller 104 via the POCI connection.

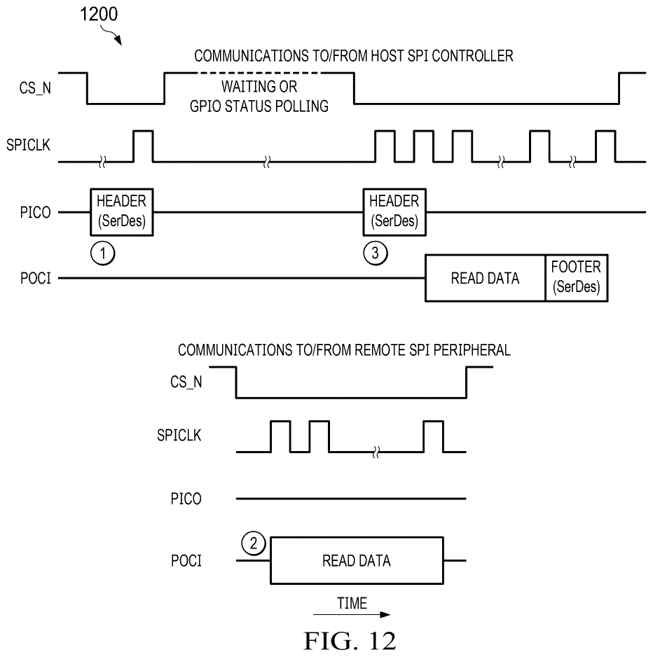

FIG. 12 illustrates a timing diagram 1200 that illustrates SPI communications for a read command from the SPI controller 104 to the SPI peripheral device 126 through the SerDes network 150 of FIG. 1, according to an embodiment of the present disclosure. FIG. 12 is described in conjunction with including the additional information in the header, as further illustrated and described, e.g., FIG. 3A. However, FIG. 12 could be described in conjunction with any technique for providing the additional information, as further described above. Also, although FIG. 12 is described in conjunction with the CS_N, SPICLK, PICO, and POCI connections of the SPI connections 106, 124a, additional or alternative connections may be used, as further illustrated and described, e.g., FIG. 2. Although FIG. 12 is described in conjunction with the SPI controller 104 and the SPI peripheral device 126, FIG. 12 may be described in conjunction with any SPI controller and any SPI peripheral device. For example, FIG. 12 may be described in conjunction with a read command between the SPI controller 142 and the SPI peripheral device 126, 127, 130, or 134 of FIG. 1. Other implementations are also possible.

As shown in the timing diagram 1200, the SPI controller 104 initiates a read command by asserting a signal on the CS_N connection (e.g., adjusting the signal on the CS_N connection from a logic high to a logic low) and transmitting a clock signal on the SPICLK connection. Alternatively, the CS_N signal may correspond to an active high protocol, where the signal CS_N signal is a high signal when the SPI controller 104 initiates a command. As described above, the signal CS_N signal adjusting to a logic low signal informs the SerDes device 108 that data transfer is occurring. Additionally, the SerDes device 108 samples the data on the PICO connection based on the clock signal (e.g., at a rising edge and/or falling edge of the clock signal).

While the CS_N signal is asserted on the CS_N connection and the clock signal is sent on the SPICLK connection, the SPI controller 104 outputs a header. The header may include additional information, such as routing information (e.g., an address of the target SPI peripheral device), the type of data transfer (e.g., read/write, remote/local, etc.), a length (e.g., the number of bytes of data to be transferred), etc. As described above, the header may not be included. Rather, the additional information may be provided by a different technique described above. After the SPI controller 104 transmits the header, the SPI controller 104 removes the assertion on the CS_N connection and stops the clock signal on the SPICLK connection. The SPI controller 104 does not reassert the CS_N connection and/or clock signal until the read data is ready, as further described below.

As described above, the SerDes network 150 receives the header sent via the SPI protocol and uses the information in the header to forward a request to the SerDes device 116 that is connected to the target SPI peripheral device 126 using the SerDes protocol. The proxy SPI controller 118 of the SerDes device 116 sends (e.g., via the interface(s) 117) the read request to the SPI peripheral device 126 using the SPI protocol. For example, the proxy SPI controller 118 transmits the header by asserting a signal on the CS_N connection (e.g., adjusting the signal on the CS_N connection from a logic high to a logic low) and transmitting a clock signal on the SPICLK connection. Alternatively, the CS_N signal may correspond to an active high protocol, where the CS_N signal is a high signal when the proxy SPI controller 118 initiates a data transfer. As described above, the CS_N signal adjusting to a logic low signal informs the SPI peripheral device 126 that data transfer is occurring. Additionally, the SPI peripheral device 126 may sample the header on the PICO connection based on the clock signal (e.g., at a rising edge and/or falling edge of the clock signal). While the CS_N signal is asserted on the CS_N connection and the clock signal is sent on the SPICLK connection, the proxy SPI controller 118 transmits a read request to the SPI peripheral device 126 via the PICO connection and receives the read data from the SPI peripheral device 126 via the POCI connection. The SPI peripheral device 126 transmits the read data based on the clock signal received via the SPICLK connection.

The proxy SPI controller 118 samples the read data on the POCI connection and transmits (e.g., using the interface(s) 117) the read data using the SerDes protocol to the proxy SPI peripheral 110 of the SerDes network 150. After a threshold duration of time, the SPI controller 104 can poll a GPIO pin and/or toggle (e.g., reassert) the CS_N connection and SPICLK connection to transmit a header (e.g., via the PICO connection, the GPIO pin, or a dedicated flow connection, such as FPD_RD_CS_N connection and the READY/RD_RDY connection of FIG. 2) to the proxy SPI peripheral 110 to determine if the read data is available in the read buffer 500 of FIG. 5. The signal on the GPIO pin indicates whether the read data is available in the read buffer 500. After determining that the data is available, the SPI controller 104 outputs the header to indicate that the SPI controller 104 is going to read data from the buffer. If the proxy SPI peripheral 110 indicates that there is data in the read buffer 500, the SPI controller 104 maintains the assertion of the CS_N and CPICLK connection and receives the read data, and optionally a footer, via the POCI connection. If the proxy SPI peripheral 110 indicates that there is no data in the read buffer 500, the SPI controller 104 can stop assertion of the CS_N and SPICLK connections and wait for a duration of time before a subsequent check.

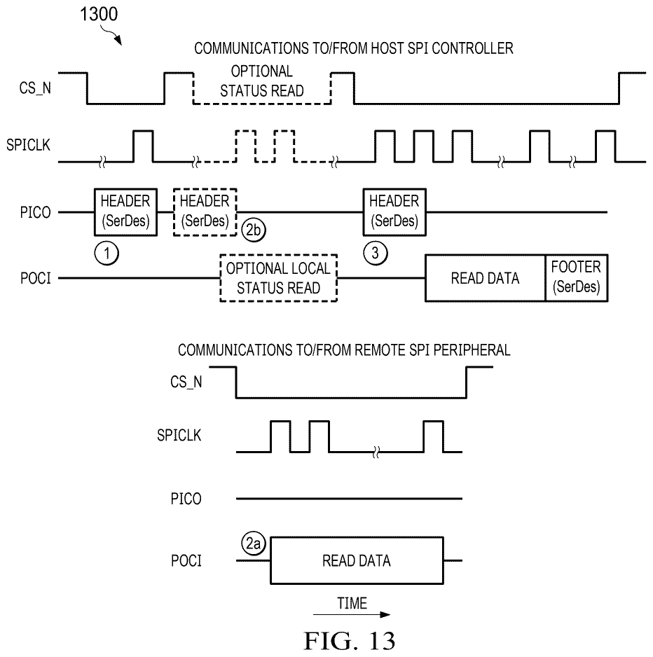

FIG. 13 illustrates a timing diagram 1300 that illustrates SPI communications for a read command from the SPI controller 104 to the SPI peripheral device 126 through the SerDes network 150 of FIG. 1, according to an embodiment of the present disclosure. FIG. 13 is described in conjunction with including the additional information in the header, as further illustrated and described, e.g., FIG. 3A. However, FIG. 10 could be described in conjunction with any technique for providing the additional information, as further described above. Also, although FIG. 13 is described in conjunction with the CS_N, SPICLK, PICO, and POCI connections of the SPI connections 106, 124a, additional or alternative connections may be used, as further illustrated and described, e.g., FIG. 2. Although FIG. 13 is described in conjunction with the SPI controller 104 and the SPI peripheral device 126, FIG. 13 may be described in conjunction with any SPI controller and any SPI peripheral device. For example, FIG. 13 may be described in conjunction with a read command between the SPI controller 142 and the SPI peripheral device 126, 127, 130, or 134 of FIG. 1. Other implementations are also possible.

The protocol corresponding to the timing diagram 1300 is similar to the protocol of the timing diagram 1200 of FIG. 12. However, instead of the SPI controller 104 polling the GPIO pin or dedicated flow control connection for read availability, after the SPI controller 104 transmits the first header and removes assertion of the CS_N and SPICLK connections, the SPI controller 104 reasserts the CS_N and SPICLK connections after a threshold amount of time and transmits a header to poll the local status register of the proxy SPI peripheral 110. After the proxy SPI peripheral 110 receives and processes the header, the proxy SPI peripheral 110 returns a status of the read buffer 500 of FIG. 5 via the POCI connection. The SPI controller 104 receives the status via the POCI connection. If the proxy SPI peripheral 110 indicates that there is data in the read buffer 500 via the POCI connection, the SPI controller 104 reasserts/toggles the CS_N and CPICLK connections and receives the read data, and optionally a footer, via the POCI connection. If the proxy SPI peripheral 110 indicates that there is no data in the read buffer 500, the SPI controller 104 can stop assertion of the CS_N and SPICLK connections and wait for a duration of time before a header for buffer status is sent.

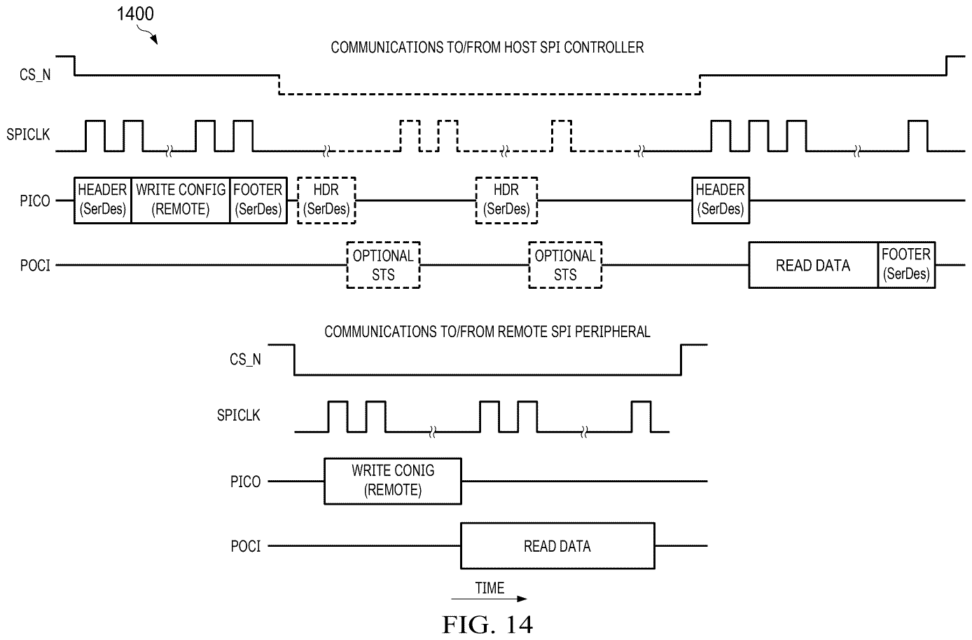

FIG. 14 illustrates a timing diagram 1400 that illustrates SPI communications for a write and read command from the SPI controller 104 to the SPI peripheral device 126 through the SerDes network 150 of FIG. 1, according to an embodiment of the present disclosure. FIG. 14 is described in conjunction with including the additional information in the header, as further illustrated and described, e.g., FIG. 3A. However, FIG. 14 could be described in conjunction with any technique for providing the additional information, as further described above. Also, although FIG. 14 is described in conjunction with the CS_N, SPICLK, PICO, and POCI connections of the SPI connections 106, 124a, additional or alternative connections may be used, as further illustrated and described, e.g., FIG. 2. Although FIG. 14 is described in conjunction with the SPI controller 104 and the SPI peripheral device 126, FIG. 14 may be described in conjunction with any SPI controller and any SPI peripheral device. For example, FIG. 14 may be described in conjunction with a write and read command between the SPI controller 142 and the SPI peripheral device 126, 127, 130, or 134 of FIG. 1. Other implementations are also possible.

As shown in the timing diagram 1400, the SPI controller 104 initiates a write command by asserting a signal on the CS_N connection (e.g., adjusting the signal on the CS_N connection from a logic high to a logic low) and transmitting a clock signal on the SPICLK connection. Alternatively, the CS_N signal may correspond to an active high protocol, where the CS_N signal is a high signal when the SPI controller 104 initiates a command. As described above, the CS_N signal adjusting to a logic low signal informs the SerDes device 108 that data transfer is occurring. Additionally, the SerDes device 108 samples the data on the PICO connection based on the clock signal (e.g., at a rising edge and/or falling edge of the clock signal).

While the CS_N signal is asserted on the CS_N connection and the clock signal is sent on the SPICLK connection, the SPI controller 104 outputs a header, followed by a first write payload and a footer on the PICO connection. The header may include additional information, such as routing information (e.g., an address of the target SPI peripheral device), the type of data transfer (e.g., read/write, remote/local, etc.), a length (e.g., the number of bytes of data to be transferred), etc. As described above, the header may not be included. Rather, the additional information may be provided by a different technique described above. The write payload may include write command information (e.g., what information to write, where to write it, etc.). The footer may include cyclic redundancy check (CRC) bits, forward error correction (FEC) bits, error correction code (ECC) bits, and/or any other data protection information, dummy bytes replacing CRC/FEC/ECC, etc. In some examples, the footer may not be included. For write-only transactions or write-read transactions, the SPI controller 104 may provide a corresponding identification of the transaction in the write payload or through a dedicated register/interface/connection prior to the transaction. For read-only transactions, the SPI controller 104 can indicate the read-only transaction through a register setting prior to a transaction.

In some examples (e.g., where the write payload is broken into chunks/portions), after the SPI controller 104 transmits the first chunk/portion via the PICO connection, the SPI controller 104 toggles the signal on the CS_N connection and pauses the clock signal on the SPICLK connection and reasserts the signal on the CS_N connection and the clock signal on the SPICLK connection for the second payload chunk/portion corresponding to the write payload. After the SPI controller 104 transmits the footer, the SPI controller 104 may wait a duration of time and/or perform a status read. For example, the SPI controller 104 may toggle the CS_N and SPICLK connections (e.g., by asserting the CS_N and SPICLK connections) and transmit a header with information corresponding to the status of the read buffer 500 of the proxy SPI peripheral 110 to determine if there is data to be read. The SPI controller 104 continues to toggle the CS_N and SPICLK connection periodically and/or aperiodically until the proxy SPI peripheral 110 indicates that there is read data in the read buffer 500 of FIG. 5.

The SerDes network 150 receives the write payload and corresponding information sent via the SPI protocol, converts the information into an SerDes protocol, and transmits the information to the SerDes device 116 that is connected to the target SPI peripheral device 126 using the SerDes protocol. The proxy SPI controller 118 of the SerDes device 116 sends (e.g., via the interface(s) 117) the write payload to the SPI peripheral device 126 using the SPI protocol and requests the read data. For example, the proxy SPI controller 118 transmits the write payload by asserting a signal on the CS_N connection (e.g., adjusting the signal on the CS_N connection from a logic high to a logic low) and asserting (e.g., transmitting) a clock signal on the SPICLK connection. Alternatively, the CS_N signal may correspond to an active high protocol, where the CS_N signal is a high signal when the proxy SPI controller 118 initiates a data transfer. As described above, the CS_N signal adjusting to a logic low signal informs the SPI peripheral device 126 that data transfer is occurring. Additionally, the SPI peripheral device 126 samples the first chunk/portion of the write payload on the PICO connection based on the clock signal (e.g., at a rising edge and/or falling edge of the clock signal). While the CS_N signal is asserted on the CS_N connection and the clock signal is sent on the SPICLK connection, the proxy SPI controller 118 transmits the write payload to the SPI peripheral device 126 via the PICO connection. After the SPI peripheral device 126 receives the write payload via the PICO connection, the SPI peripheral device 126 transmits the read data via the POCI connection based on the clock signal on the SPICLK connection during the same CS_N cycle as the reception of the write payload.

After a duration of time or after the SPI controller 104 determines that the read buffer 500 stores read data, the SPI controller 104 can poll a GPIO pin and/or toggle (e.g., reassert) the CS_N connection and SPICLK connection to transmit a header (e.g., via the PICO connection, the GPIO pin, or a dedicated flow connection, such as FPD_RD_CS_N connection and the READY/RD_RDY connection of FIG. 2) to the proxy SPI peripheral 110 to determine if the read data is available in the read buffer 500 of FIG. 5. If the proxy SPI peripheral 110 indicates that there is data in the read buffer 500, the SPI controller 104 maintains the assertion of the CS_N and CPICLK connection and receives the read data, and optionally a footer, via the POCI connection. If the proxy SPI peripheral 110 indicates that there is no data in the read buffer 500, the SPI controller 104 can stop assertion of the CS_N and SPICLK connections and wait for a duration of time before a subsequent check. However, the SPI controller 104 can read the data according to any of the protocols described above in conjunction with FIGS. 9-13.

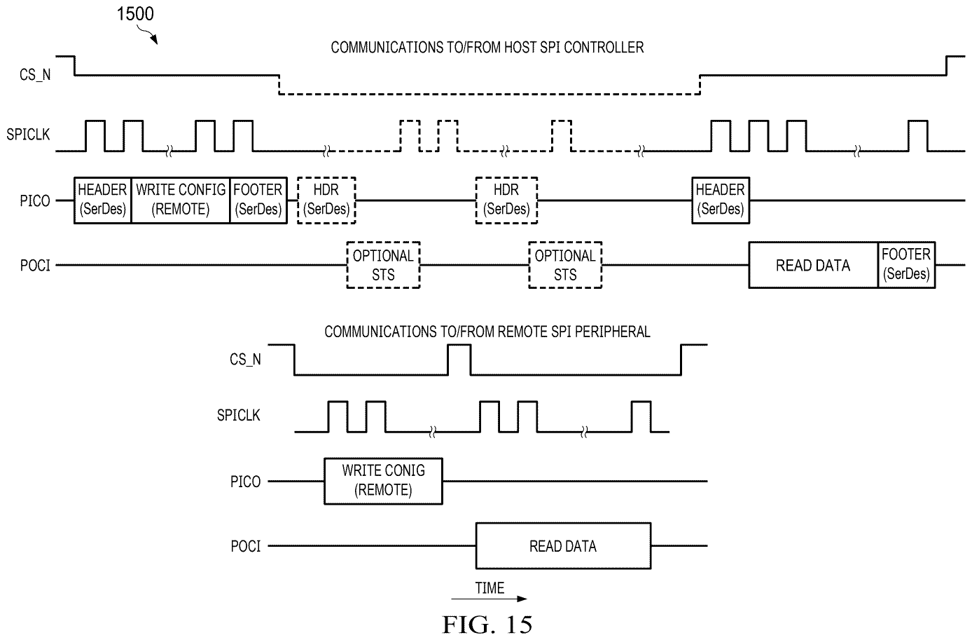

FIG. 15 illustrates a timing diagram 1500 that illustrates SPI communications for a write and read command from the SPI controller 104 to the SPI peripheral device 126 through the SerDes network 150 of FIG. 1, according to an embodiment of the present disclosure. FIG. 15 is described in conjunction with including the additional information in the header, as further illustrated and described, e.g., FIG. 3A. However, FIG. 15 could be described in conjunction with any technique for providing the additional information, as further described above. Also, although FIG. 15 is described in conjunction with the CS_N, SPICLK, PICO, and POCI connections of the SPI connections 106, 124a, additional or alternative connections may be used, as further illustrated and described, e.g., FIG. 2. Although FIG. 15 is described in conjunction with the SPI controller 104 and the SPI peripheral device 126, FIG. 15 may be described in conjunction with any SPI controller and any SPI peripheral device. For example, FIG. 15 may be described in conjunction with a write and read command between the SPI controller 142 and the SPI peripheral device 126, 127, 130, or 134 of FIG. 1. Other implementations are also possible.

The protocol corresponding to the timing diagram 1500 is similar to the protocol of the timing diagram 1400 of FIG. 14. However, instead of the proxy SPI controller 118 maintaining an assertion of the CS_N and SPICLK connections for the transmission of the write payload to the SPI peripheral device 126 via the PICO connection and the transmission of the read payload to the proxy SPI controller 118 via the POCI connection, the proxy SPI controller 118 toggles the CS_N and SPICLK connections between the transmission of the write payload via the PICO connection and the trans mission of the read payload via the POCI connection.

Although some of the examples described herein are described in conjunction with a four-wire SPI protocol (e.g., CS_N, SPICLK, PICO, POCI) which can support full-duplex transfers, at least some of the examples described herein could be implemented in a three-wire SPI protocol. A three-wire SPI protocol is a half-duplex protocol where the third pin/connection supports both PICO and POCI connection with a bus turn-around. Such a three-wire SPI protocol could be used in conjunction with the above FIGS. 10-15.

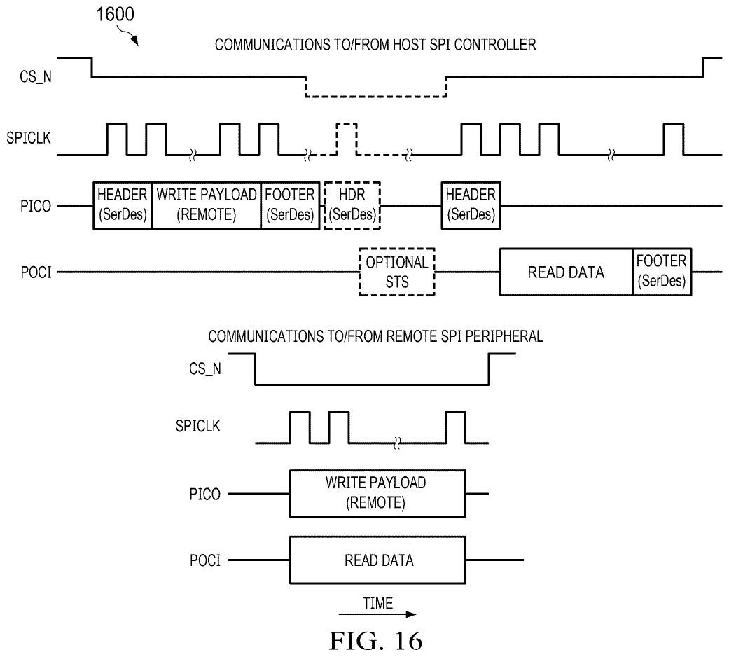

FIG. 16 illustrates a timing diagram 1600 that illustrates SPI communications for a write and read command from the SPI controller 104 to the SPI peripheral device 126 through the SerDes network 160 of FIG. 1, according to an embodiment of the present disclosure. FIG. 16 is described in conjunction with including the additional information in the header, as further illustrated and described, e.g., FIG. 3A. However, FIG. 16 could be described in conjunction with any technique for providing the additional information, as further described above. Also, although FIG. 16 is described in conjunction with the CS_N, SPICLK, PICO, and POCI connections of the SPI connections 106, 124a, additional or alternative connections may be used, as further illustrated and described, e.g., FIG. 2. Although FIG. 16 is described in conjunction with the SPI controller 104 and the SPI peripheral device 126, FIG. 16 may be described in conjunction with any SPI controller and any SPI peripheral device. For example, FIG. 16 may be described in conjunction with a write and read command between the SPI controller 142 and the SPI peripheral device 126, 127, 130, or 134 of FIG. 1. Other implementations are also possible.

The protocol corresponding to the timing diagram 1600 is similar to the protocol of the timing diagram 1400 of FIG. 14. However, instead of the SPI peripheral device 126 waiting to receive the write payload before sending the read data, the SPI peripheral device 126 transmits the read payload to the proxy SPI controller 118 via the POCI connection at the same time as (e.g., simultaneously to) the SPI peripheral device 126 receives the write payload from the proxy SPI controller 118 via the PICO connection.

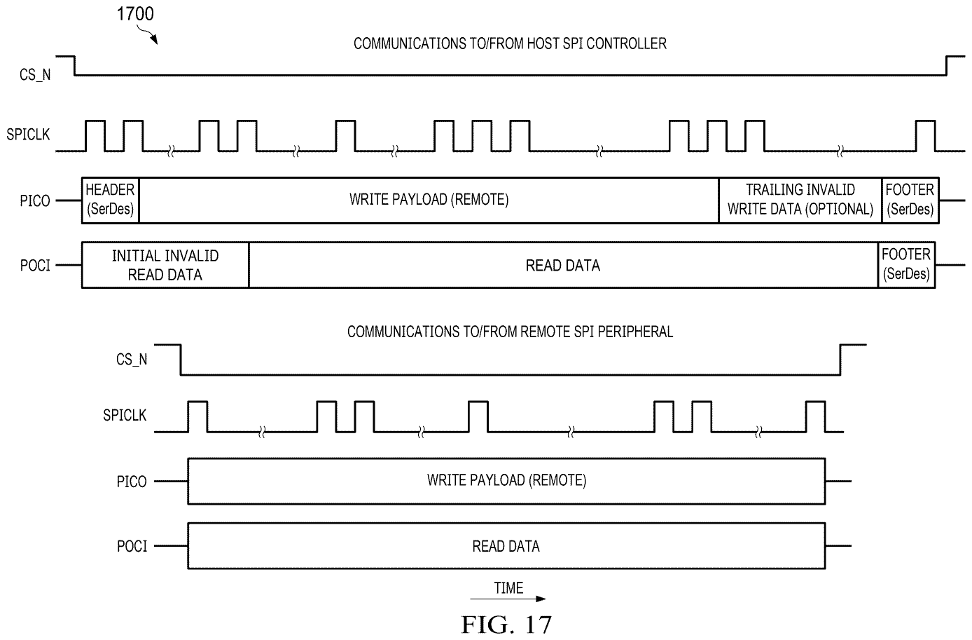

FIG. 17 illustrates a timing diagram 1700 that illustrates SPI communications for a write and read command from the SPI controller 174 to the SPI peripheral device 126 through the SerDes network 150 of FIG. 1, according to an embodiment of the present disclosure. FIG. 17 is described in conjunction with including the additional information in the header, as further illustrated and described, e.g., FIG. 3A. However, FIG. 17 could be described in conjunction with any technique for providing the additional information, as further described above. Also, although FIG. 17 is described in conjunction with the CS_N, SPICLK, PICO, and POCI connections of the SPI connections 106, 124a, additional or alternative connections may be used, as further illustrated and described, e.g., FIG. 2. Although FIG. 17 is described in conjunction with the SPI controller 104 and the SPI peripheral device 126, FIG. 17 may be described in conjunction with any SPI controller and any SPI peripheral device. For example, FIG. 17 may be described in conjunction with a write and read command between the SPI controller 142 and the SPI peripheral device 126, 127, 130, or 134 of FIG. 1. Other implementations are also possible.

As shown in the timing diagram 1700, the SPI controller 104 initiates a read command by asserting a signal on the CS_N connection (e.g., adjusting the signal on the CS_N connection from a logic high to a logic low) and transmitting a clock signal on the SPICLK connection. Alternatively, the CS_N signal may correspond to an active high protocol, where the CS_N signal is a high signal when the SPI controller 104 initiates a command. As described above, the CS_N signal adjusting to a logic low signal informs the SerDes device 108 that data transfer is occurring. Additionally, the SerDes device 108 samples the data on the PICO connection based on the clock signal (e.g., at a rising edge and/or falling edge of the clock signal).

While the CS_N signal is asserted on the CS_N connection and the clock signal is sent on the SPICLK connection, the SPI controller 104 outputs a header, the write payload information, and a footer. The header may include additional information, such as routing information (e.g., an address of the target SPI peripheral device), the type of data transfer (e.g., read/write, remote/local, etc.), a length (e.g., the number of bytes of data to be transferred), etc. As described above, the header may not be included. Rather, the additional information may be provided by a different technique described above. The write payload may include write command information (e.g., what information to write, where to write it, etc.). The footer may include cyclic redundancy check (CRC) bits, forward error correction (FEC) bits, error correction code (ECC) bits, and/or any other data protection information, dummy bytes replacing CRC/FEC/ECC, etc. In some examples, the footer may not be included. The SPI controller 104 transmits the footer after a threshold amount of time after the write payload is complete. The threshold amount of time is to ignore trailing invalid write data based on an end indication so that the footer is transmitted after the read data is received via the POCI connection, as further described below.

As described above, the SerDes network 150 receives the header sent via the SPI protocol, and uses the information in the header to forward a read request and the write payload (via the PICO connection) to the SerDes device 116 that is connected to the target SPI peripheral device 126 using the SerDes protocol. The proxy SPI controller 118 of the SerDes device 116 sends (e.g., via the interface(s) 117) the read request and write payload to the SPI peripheral device 126 using the SPI protocol. For example, the proxy SPI controller 118 transmits the write payload and receives the read payload by asserting a signal on the CS_N connection (e.g., adjusting the signal on the CS_N connection from a logic high to a logic low) and transmitting a clock signal on the SPICLK connection. Alternatively, the CS_N signal may correspond to an active high protocol, where the CS_N signal is a high signal when the proxy SPI controller 118 initiates a data transfer. As described above, the CS_N signal adjusting to a logic low signal informs the SPI peripheral device 126 that data transfer is occurring. Additionally, the SPI peripheral device 126 samples the write payload data on the PICO connection based on the clock signal (e.g., at a rising edge and/or falling edge of the clock signal) and outputs the read data on the POCI connection based on the clock signal. While the CS_N signal is asserted on the CS_N connection and the clock signal is sent on the SPICLK connection, the proxy SPI controller 118 transmits a read request and/or write payload to the SPI peripheral device 126 via the PICO connection and receives the read data from the SPI peripheral device 126 via the POCI connection (e.g., simultaneously). The SPI peripheral device 126 transmits the read data based on the clock signal received via the SPICLK connection.

The proxy SPI controller 118 samples the read data on the POCI connection and transmits (e.g., using the interface(s) 117) the read data using the SerDes protocol to the proxy SPI peripheral 110 of the SerDes network 150. The proxy SPI peripheral 110 forwards the read data (e.g., using the interface(s) 109) based on the clock signal on the SPICLK connection of the SPI connections 106. The read data is transmitted via the POCI connection of the SPI connections 106 so that the SPI controller 104 can sample the read data using the SPI protocol. The SPI controller 104 discards the initial sampled read data because the initial data on the POCI connection is invalid. The number of bytes before the valid read data is received via the POCI connection is known. Thus, the SPI controller 104 discards a known number of invalid bytes received via the POCI connection until the valid read data is received. In some examples, the number of invalid bytes is based on a configurable maximum SerDes delay. In this manner, the SPI controller 104 can transmit at least a portion of the write payload via the PICO connection while obtaining at least a portion of the read payload via the POCI connection.

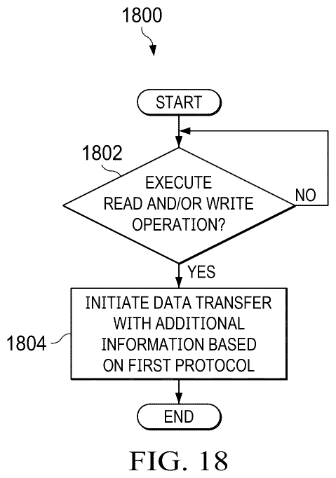

FIG. 18 is a flowchart of embodiment method 1800, according to an embodiment of the present disclosure. Method 1800 may be at least one of executed, instantiated, or performed by programmable circuitry to implement the SPI controller 104 of FIG. 1 to perform a data transfer (e.g., corresponding to a read command or a write command). Although the flowchart of FIG. 18 is described in conjunction with the SPI controller 104, the flowchart may be described in conjunction with any SPI controller, such as the SPI controller 104 or 142. The steps/blocks of FIG. 18 are described with respect to the SPI controller 104 of FIG. 1.

Method 1800 begins at block 1802, at which the SPI controller 104 determines if instructions have been received to execute a read and/or write operation from/to a SPI peripheral device within the system 100. For example, the host processor 102 may output an instruction to read data from the SPI peripheral device 126 and/or write data to the SPI peripheral device 126. If the SPI controller 104 determines that instructions have not been received to execute a read and/or write operation from/to a SPI peripheral device (block: 1802: NO), control returns to block 1802. If the SPI controller 104 determines that instructions have been received to execute a read and/or write operation from/to a SPI peripheral device (block 1802: YES), the SPI controller 104 initiates a data transfer with additional information based on a first protocol (e.g., an SPI protocol). For example, the SPI controller 104 can initiate a data transfer by asserting the CS_N connection (or the FPD_WR_CS_N or FPD_RD_CS_N connection) and asserting the SPICLK connection. The SPI controller 104 can assert the CS_N connection by adjusting the signal transmitted on the CS_N connection from a first logic value (e.g., one or 3 Volts) to a second logic value (e.g., zero or 0 Volts). The SPI controller 104 can assert the SPICLK connection by transmitting a clock signal on the SPICLK connection. After the CS_N and SPICLK connections are asserted, the SPI controller 104 may transmit a header (e.g., which can include information related to whether the command is for a read and/or write operation, routing information, etc.) and/or write payload information (e.g., for a write command or a read and write command) on the PICO connection. Further details describing examples of SPI controller communication are further described above in conjunction with FIGS. 6-17. The SPI controller 104 transmits the additional information using one of the techniques described above in conjunction with FIGS. 3A-3C. As described above, the additional information may include SPI peripheral routing information (e.g., an identifier, an address, etc. of an SPI peripheral device), type of data transfer/command (e.g., read, write, read/write, etc.), transfer length, etc.

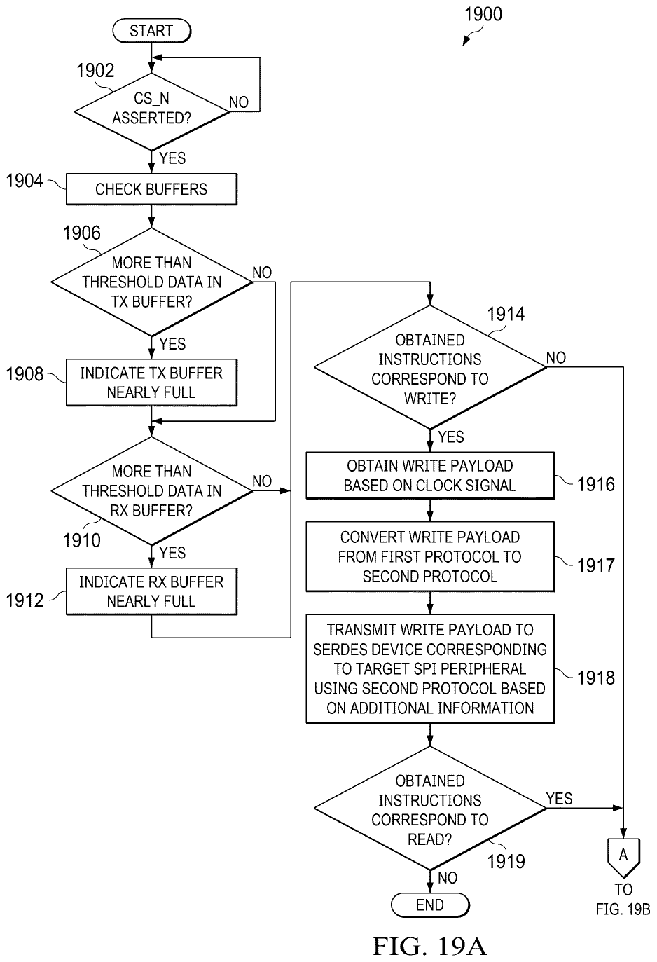

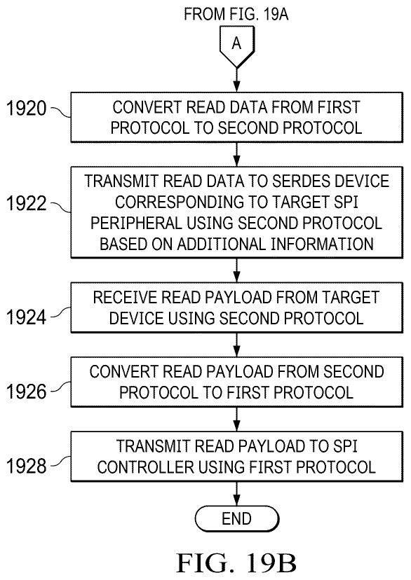

FIGS. 19A and 19B include a flowchart of embodiment method 1900, according to an embodiment of the present disclosure. Method 1900 may be at least one of executed, instantiated, or performed by programmable circuitry to implement the proxy SPI peripheral 110 of FIG. 1 to perform a data transfer (e.g., corresponding to a read command or a write command from the SPI controller 104 to the SPI peripheral device 126). Although the flowchart of FIGS. 19A and 19B are described in conjunction with the proxy SPI peripheral 110 and the SPI peripheral device 126, the flowchart may be described in conjunction with any proxy SPI peripheral (e.g., such as any one of the proxy SPI peripheral 110 or 148) and/or any SPI peripheral device (e.g., such as any one of the SPI peripherals 126, 127, 130, 131). The steps/blocks of FIGS. 19A and 19B are described with respect to the proxy SPI peripheral 110 of FIG. 1.

Method 1900 begins at block 1902, at which the proxy SPI peripheral 110 determines whether the CS_N connection of the SPI connection 106 is asserted. As described above, the SPI controller 104 can assert the CS_N connection by adjusting the signal on the CS_N connection from a logic high to a logic low value. Thus, the proxy SPI peripheral 110 can determine that the CS_N connection is asserted when the signal on the CS_N connection corresponds to a logic zero. If the proxy SPI peripheral 110 determines that the CS_N connection has not been asserted (block 1902: NO), control returns to block 1902 until the CS_N connection is asserted. If the proxy SPI peripheral 110 determines that the CS_N connection has been asserted (block 1902: YES), the proxy SPI peripheral 110 checks the buffers 400, 500 to determine the amount of data stored in the buffers 400, 500 (block 1904).

At block 1906, the proxy SPI peripheral 110 determines if there is more than a threshold amount of data stored in the TX buffer 400. More than a threshold amount of data in the TX buffer 400 may result in overflow and/or packet loss if not mitigated. More than a threshold amount of data in the TX buffer 400 may correspond to a bottleneck within the SerDes device 108, the aggregator 114, the SerDes device 116, and/or the SPI peripheral device 126. Additionally, more than a threshold amount of data in the TX buffer 400 may correspond to the clock at the SerDes device 116 being slower than the clock at the host processor 102 (e.g., leading to a bottleneck). If the proxy SPI peripheral 110 determines that there is not more than a threshold amount of data in the TX buffer 400 (block 1906: NO), control continues to block 1910, as further described below. If the proxy SPI peripheral 110 determines that there is more than a threshold amount of data in the TX buffer 400 (block 1906: YES), the proxy SPI peripheral 110 indicates that the TX buffer 400 is nearly full (block 1908). For example, the proxy SPI peripheral 110 transmits (via one of the interface(s) 109) an indication that the TX buffer 400 is nearly full to the SPI controller 104 via the READY, WR_RDY, and/or RD_RDY connection of the SPI connection 106 or another connection (e.g., GPIO, I2C, etc.). In this manner, the SPI controller 104 can adjust the clock signal to slow down the transmission of additional data (e.g., write payloads, headers, etc.) to the write buffer 400. The SPI controller 104 may slow down the clock signal using a phase-locked loop or other technique, or may skip one or more clock pulses. In some examples, the proxy SPI peripheral 110 can send the indication that the TX buffer 400 is nearly full to the proxy SPI control 118 to increase its clock signal to increase the speed of the processing of headers, write payload data, etc.

At block 1910, the proxy SPI peripheral 110 determines if there is more than a threshold amount of data stored in the RX buffer 500. More than a threshold amount of data in the RX buffer 500 may result in overflow and/or packet loss if not mitigated. More than a threshold amount of data in the RX buffer 500 may correspond to a bottleneck within the SerDes device 108 or the SPI controller 104. Additionally, more than a threshold amount of data in the RX buffer 500 may correspond to the clock at the SPI controller 104 being slower than the clock at the proxy SPI controller 118 (e.g., leading to a bottleneck). If the proxy SPI peripheral 110 determines that there is not more than a threshold amount of data in the RX buffer 500 (block 1910: NO), control continues to block 1914, as further described below. If the proxy SPI peripheral 110 determines that there is more than a threshold amount of data in the RX buffer 500 (block 1910: YES), the proxy SPI peripheral 110 indicates that the RX buffer 500 is nearly full (block 1912). For example, the proxy SPI peripheral 110 transmits (via one of the interface(s) 109) an indication that the RX buffer 500 is nearly full to the proxy SPI controller 118 via the SerDes connections 112. In this manner, the proxy SPI controller 118 can adjust the clock signal to slow down the transmission of additional data (e.g., read payloads, headers, etc.) to the read buffer 500. The proxy SPI controller 118 may slow down the clock signal using a phase-locked loop or other technique, or may skip one or more clock pulses, as further described below. In some examples, the proxy SPI peripheral 110 can send the indication that the RX buffer 500 is nearly full to the SPI controller 104 to trigger the SPI controller 104 to increase its clock signal to increase the speed of the processing of read data.

Although block 1906-1912 corresponds to flow control to reduce and/or mitigate buffer overload, FIG. 19 may additionally include blocks to check the amount of data in the buffer to a minimum threshold to adjust the clock signal(s) to avoid underflow, as further illustrated and described, e.g., FIG. 4.

At block 1914, the proxy SPI peripheral 110 determines if the information received via the PICO connection of the SPI connection 106 or another dedicated pin/connection corresponds to a write command (e.g., a write command or a read and write command). For example, the proxy SPI peripheral 110 may receive (e.g., via one of the interface(s) 109) additional data identifying the SPI peripheral device 126 and/or a read, write, or read and write command. The proxy SPI peripheral 110 can obtain the additional information via one of the techniques described above, in conjunction with FIGS. 3A-3C. If the proxy SPI peripheral 110 determines that the received additional information does not correspond to a write instruction, but rather a read instruction (block 1914: NO), control continues to block 1920 of FIG. 19B to perform a read command protocol, as further described below. If the proxy SPI peripheral 110 determines that the received additional information corresponds to write instructions (block 1914: YES), the proxy SPI peripheral 110 receives the write payload using one of the interface(s) 109 based on the clock signal on the SPICLK connection (block 1916). For example, the proxy SPI peripheral 110 samples the write payload on the PICO connection of the SPI connection 106 based on the clock signal. The proxy SPI peripheral 110 stores the received write payload in the TX buffer 400 of FIG. 4.

At block 917, the proxy SPI peripheral 110 converts the write data from the first SPI protocol to a second SerDes protocol. At block 1918, the proxy SPI peripheral 110 transmits (e.g., using one of the interface(s) 109) the write payload to the SerDes device corresponding to the target SPI peripheral identified in the additional information (e.g., the SerDes device 116 connected to the SPI peripheral device 126). For example, the proxy SPI peripheral 110 outputs the write payload using the SerDes connection 112 to the SerDes device 116 via the aggregator 114 using the SerDes protocol. At block 1919, the proxy SPI peripheral 110 determines if the received instructions correspond to a read (e.g., a write and read operation). If the proxy SPI peripheral 110 determines that the received instructions correspond to a read (block 1919: YES), control continues to block 1920 of FIG. 19A. If the proxy SPI peripheral 110 determines that the received instructions do not correspond to a read (block 1919: NO), the instructions end.

At block 1920, the proxy SPI peripheral 110 converts the read data (e.g., the read instructions including one or more of an identifier and/or address of the target SPI peripheral device, the read instruction, a memory address to read from, etc.) from the first SPI protocol to the second SerDes protocol. At block 1922, the proxy SPI peripheral 110 (e.g., using one of the interface(s) 109) transmits the read data to the SerDes device corresponding to the target SPI peripheral identified in the additional information (e.g., the SerDes device 116 connected to the SPI peripheral device 126). For example, the proxy SPI peripheral 110 outputs the read data using the SerDes connection 112 to the SerDes device 116 via the aggregator 114 using the SerDes protocol. At block 1924, the proxy SPI peripheral 110 receives (e.g., using one of the interface(s) 109) the read payload from the target SPI using the second SerDes protocol via the SerDes device 116, the aggregator 114, and the SerDes connection 112. The proxy SPI peripheral 110 stores the received read payload in the RX buffer 500 of FIG. 5. At block 1926, the proxy SPI peripheral 110 converts the read payload from the second SerDes protocol to the first SPI protocol. At block 1928, the proxy SPI peripheral 110 uses one of the interface(s) 109 to transmit the read payload to the SPI controller 104 using the first SPI protocol. For example, the proxy SPI peripheral 110 waits until the CS_N and SPICLK connections are asserted to transmit the read payload on the POCI connection of the SPI connection 106 based on the clock signal. Further details, additional, and/or alternative techniques for executing a read instruction, a write instruction, or a read and write instruction are further described above in conjunction with FIGS. 4-17.

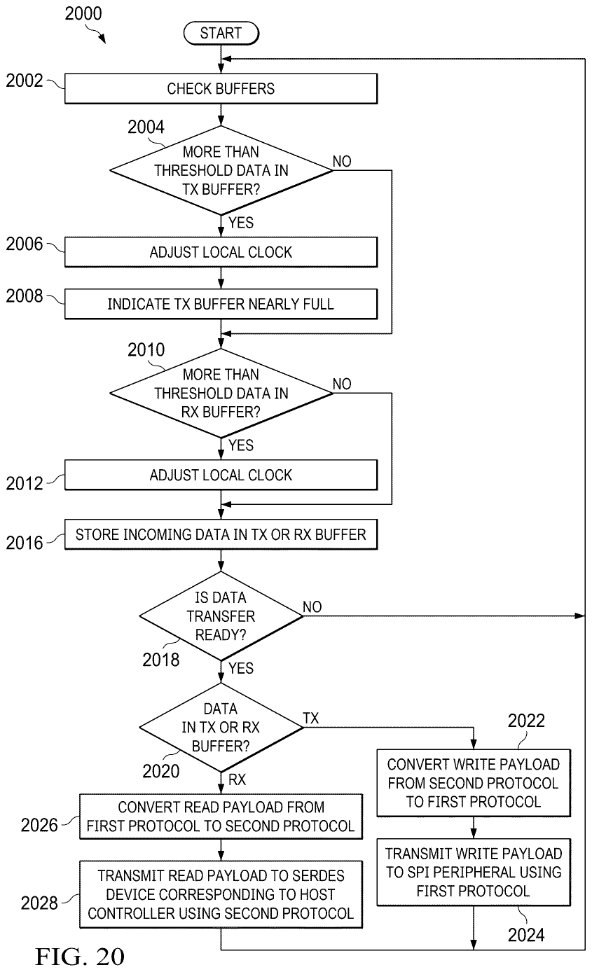

FIG. 20 includes a flowchart of embodiment method 2000, according to an embodiment of the present disclosure. Method 2000 may be at least one of executed, instantiated, or performed by programmable circuitry to implement the proxy SPI controller 118 of FIG. 1 to perform a data transfer (e.g., corresponding to a read command or a write command from the SPI controller 104 to the SPI peripheral device 126). Although the flowchart of FIG. 20 is described in conjunction with proxy SPI controller 118 and the SPI peripheral device 126, the flowchart may be described in conjunction with any proxy SPI controller (e.g., such as any one of the proxy SPI controllers 115, 118 or 122) and/or any SPI peripheral device (e.g., such as any one of the SPI peripherals 126, 127, 130, 131). The steps/blocks of FIG. 20 are described with respect to the proxy SPI controller 118 of FIG. 1.

Method 2000 begins at block 2002, at which the proxy SPI controller 118 checks the buffers 402, 502 to determine the amount of data stored in the buffers 402, 502. At block 2004, the proxy SPI controller 118 determines if there is more than a threshold amount of data stored in the TX buffer 402. More than a threshold amount of data in the TX buffer 402 may result in overflow and/or packet loss if not mitigated. More than a threshold amount of data in the TX buffer 402 may correspond to a bottleneck within the SerDes device 116 and/or the SPI peripheral device 126. Additionally, more than a threshold amount of data in the TX buffer 402 may correspond to the clock at the SerDes device 116 being slower than the clock at the host processor 102 (e.g., leading to a bottleneck). If the proxy SPI controller 118 determines that there is not more than a threshold amount of data in the TX buffer 402 (block 2004: NO), control continues to block 2010, as further described below. If the proxy SPI controller 118 determines that there is more than a threshold amount of data in the TX buffer 402 (block 2004: YES), the proxy SPI controller 118 adjusts the local clock used to generate the clock signal on the SPICLK connection of the SPI connection 124a (block 2006). For example, the proxy SPI controller 118 may increase the frequency of the clock signal using a phase-locked loop so that the SPI peripheral device 126 receives data from the TX buffer 402 faster to decrease the amount of data in the TX buffer 402. At block 2008, the proxy SPI controller 118 indicates that the TX buffer 402 is nearly full. For example, the proxy SPI controller 118 transmits (via one of the interface(s) 109) an indication that the TX buffer 402 is nearly full to the SPI controller 104 (e.g., via the aggregator 114 and the SerDes device 108). In this manner, the SPI controller 104 can adjust the clock signal to slow down the transmission of additional data (e.g., write payloads, headers, etc.) to the SerDes device 116. The SPI controller 104 may slow down the clock signal using a phase-locked loop or other technique, or may skip one or more clock pulses.

At block 2010, the proxy SPI controller 118 determines if there is more than a threshold amount of data stored in the RX buffer 502. More than a threshold amount of data in the RX buffer 502 may result in overflow and/or packet loss if not mitigated. More than a threshold amount of data in the RX buffer 502 may correspond to a bottleneck within the SerDes device 116. Additionally, more than a threshold amount of data in the RX buffer 502 may correspond to the clock at the SPI controller 104 being slower than the clock at the proxy SPI controller 118 (e.g., leading to a bottleneck). If the proxy SPI controller 118 determines that there is not more than a threshold amount of data in the RX buffer 502 (block 2010: NO), control continues to block 2106, as further described below. If the proxy SPI controller 118 determines that there is more than a threshold amount of data in the RX buffer 502 (block 2010: YES), the proxy SPI controller 118 adjusts its local clock to slow down the clock signal on the SPICLK connection of the SPI connection 124a (block 2012). In this manner, the SPI peripheral device 126 slows down the transmission of read data to the proxy SPI controller 118 to give time to the proxy SPI controller 118 to transmit the read payloads currently in the RX buffer 502. The proxy SPI controller 118 may slow down the clock signal using a phase-locked loop or other technique, or may skip one or more clock pulses. In some examples, the proxy SPI controller 118 can additionally or alternatively transmit (via one of the interface(s) 117) an indication that the RX buffer 502 is nearly full to the SPI controller 104 via the aggregator 114, the SerDes device 108, and the SerDes connections 112. In this manner, the proxy SPI controller 118 can adjust the clock signal to slow down the transmission of additional read requests, which slows down the rate at which read payloads are stored in the RX buffer 502.

Although block 2004-2012 corresponds to flow control to reduce and/or mitigate buffer overload, FIG. 20 may additionally include blocks to check the amount of data in the buffer to a minimum threshold to adjust the clock signal(s) to avoid underflow, as further illustrated and described, e.g., FIG. 4.

At block 2016, the proxy SPI controller 118 can store incoming write payload data from the SPI controller 104 (e.g., via the SerDes device 108) into the TX buffer 402 and the incoming read payload data (e.g., via the SPI peripheral device 126) into the RX buffer 502, if incoming data is received. At block 2018, the proxy SPI controller 118 determines if data transfer is ready. For example, the SPI peripheral device 126 may indicate whether it is ready to obtain data by transmitting a signal on a connection (e.g., the READY, RD_EADY_WR_RDY connection) of the SPI connection 124a. Thus, the proxy SPI controller 118 can monitor the connection of the SPI connection 124a to determine if data transfer is ready. Additionally, the proxy SPI controller 118 can monitor the SerDes connection 112 to determine whether the SerDes device 108 has output an indication that it is ready or not ready for data transfer.

At block 2020, the proxy SPI controller 118 determines whether there is data in the TX buffer 402 or the RX buffer 502. If there is no data in either buffer, control returns to block 2002 and, in some examples, the proxy SPI controller 118 can output an indication of underflow to the SPI controller 104 via the SerDes device 108. If the proxy SPI controller 118 determines that there is data in the TX buffer 402 (block 2020: TX), the proxy SPI controller 118 converts the write payload from the second SerDes protocol to a first SPI protocol (block 2022). At block 2024, the proxy SPI controller 118 transmits (e.g., using one of the interface(s) 117) the write payload from the TX buffer 402 to the SPI peripheral device 126 using the SPI protocol. For example, the proxy SPI controller 118 asserts the CS_N and SPICLK connections of the SPI connection 124a and transmits the write payload via the PICO connection of the SPI connection 124a. In this manner, the SPI peripheral device 126 can obtain the write payload by sampling the PICO connection based on the clock signal on the SPICLK connection.

If the proxy SPI controller 118 determines that there is data in the TX buffer 402 (block 2020: RX), the proxy SPI controller 118 converts the read payload from the first SPI protocol to a second SerDes protocol (block 2026). At block 2028, the proxy SPI controller 118 transmits (e.g., using one of the interface(s) 117) the read payload from the TX buffer 402 to the SerDes device 108 using the SerDes protocol. If the proxy SPI controller 118 determines that there is data in both the RX buffer 502 and the TX buffer 402, control continues to both block 2022 and 2026. Further details, additional, and/or alternative techniques for executing a read instruction, a write instruction, or a read and write instruction are further described above in conjunction with FIGS. 4-17.

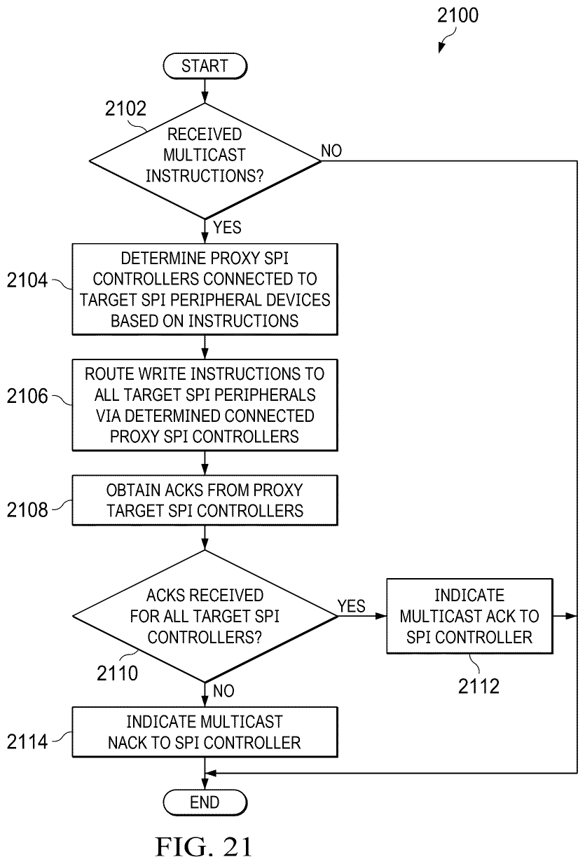

FIG. 21 includes a flowchart of embodiment method 2100, according to an embodiment of the present disclosure. Method 2100 may be at least one of executed, instantiated, or performed by programmable circuitry to implement the proxy SPI peripheral 110 of FIG. 1 to perform a multicast write to multiple proxy SPI controllers connected to target SPI peripheral devices (e.g., the one or more of the SPI peripheral devices 126, 127, 130, 134). Although the flowchart of FIG. 21 is described in conjunction with the proxy SPI controller 118 and the SPI peripheral devices 126, 127, the flowchart may be described in conjunction with any proxy SPI peripheral (e.g., such as any one of the proxy SPI peripherals 110 or 148) and/or any SPI peripheral device (e.g., such as any one of the SPI peripherals 126, 127, 130, 131). The steps/blocks of FIG. 21 are described with respect to the proxy SPI peripheral 110 of FIG. 1. However, in some examples, the steps/block of FIG. 21 can be described with respect to the proxy SPI controller 118 of FIG. 1 (e.g., gathering ACKS from a plurality of connected peripheral SPI devices before sending a single ACK/NACK for the plurality of connected peripheral SPI devices).

Method 2100 begins at block 2102, at which proxy SPI peripheral 110 determines if (e.g., using one of the interface(s) 117) the interface(s) 109 have received multicast instructions from the SPI controller 104 via the SPI connection 106. The multicast instructions may include a list of SPI peripheral addresses/identifiers for a multicast write command. If the proxy SPI peripheral 110 determines that multicast instructions have not been received (block 2102: NO), the instructions end. If the proxy SPI peripheral 110 determines that multicast instructions have been received (block 2102: YES), the proxy SPI peripheral 110 determines which of the proxy SPI controllers are connected to target SPI peripheral devices based on the instructions (block 2104). For example, if the multicast instructions include a list that identifies the SPI peripheral device 126 and the SPI peripheral device 130, the proxy SPI peripheral 110 identifies the proxy SPI controllers 118, 122 that are connected to the target peripheral SPI devices 126, 130. At block 2106, the proxy SPI peripheral 110 routes (e.g., using one of the interface(s) 109) the write instructions/payload to all the proxy SPI controllers connected to the target SPI peripheral devices 126, 130 using the SerDes connection 112 and the SerDes protocol. At block 2108, after sending the write instructions/payload to the proxy SPI controllers 118, 122 connected to the target SPI peripheral devices 126, 130, the proxy SPI peripheral 110 receives (e.g., using one of the interface(s) 109) ACKS from the proxy SPI controllers 118, 122 via the SerDes connection 112. For example, each proxy SPI controller 118 obtains the multicast instructions, transmits instructions to the connected target SPI peripheral device, and waits for ACKS. After all corresponding ACK(s) are received (from each connected target SPI peripheral device), the Proxy SPI controllers 118, 122 transmit an ACK to the proxy SPI peripheral 110.

At block 2110, the proxy SPI peripheral 110 determines if ACKs have been received from all proxy SPI controllers connected to target SPI peripheral devices (e.g., the SPI controllers 118, 122 connected to target SPI peripheral devices 126, 127). If all the ACKs from the proxy SPI controllers connected to the target SPI peripheral devices (e.g., ACKs from both SPI proxy controllers 118, 122) (block 2110: YES), the proxy SPI controller 118 indicates a multicast ACK to the SPI controller 104 (block 2112). For example, the proxy SPI peripheral 110 can transmit (e.g., using one of the interface(s) 109) a single acknowledgment corresponding to an accumulation of the ACKs from all the proxy SPI controllers 118, 122 to the SPI controller 104 via the SPI connection 106.

If all the ACKs from the proxy SPI controllers 118, 122 connected to the target SPI peripheral devices 126, 130 have not been received (block 2110: NO), the proxy SPI peripheral 110 can indicate a multicast NACK to the SPI controller 104 (block 2114). For example, the proxy SPI peripheral 110 can transmit (e.g., using one of the interface(s) 109) a NACK corresponding to a multicast write failure to the target SPI peripheral devices 118, 122 to the SPI controller 104 using the SPI protocol. In some examples, before sending the NACK, the proxy SPI peripheral 110 may retry transmission of the multicast write (one or more times) to the proxy SPI controllers that did not return an ACK before sending a NACK to the SPI controller 104 via the SPI connection 106.

FIG. 21 is described in conjunction with the proxy SPI peripheral 110 transmitting a 1:N multicast communication and collecting the “ACK” to provide an N:1 composite ACK to the host SPI controller. Such a technique does not require support from the rest of the SerDes network 150. However, because fanout happens at the proxy SPI peripheral 110, multicast traffic is high. In some examples, based on the routes to the target SPI peripherals, the proxy SPI peripheral 110 can send one packet per SerDes link. In such examples, subsequent SerDes devices multiply the packet as per the routes and send it to the target SPI peripherals. Such a technique results in a lower amount of traffic but requires support from the rest of the SerDes network 150.

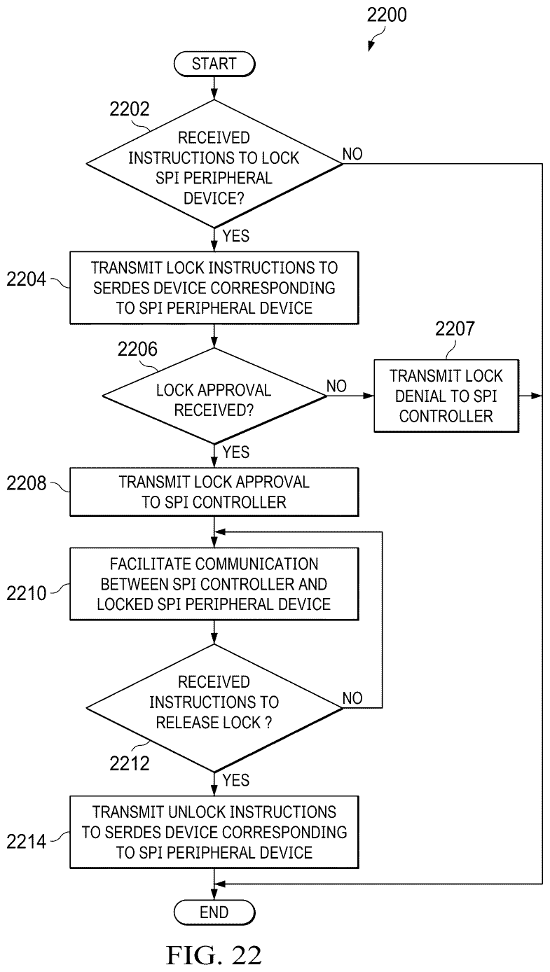

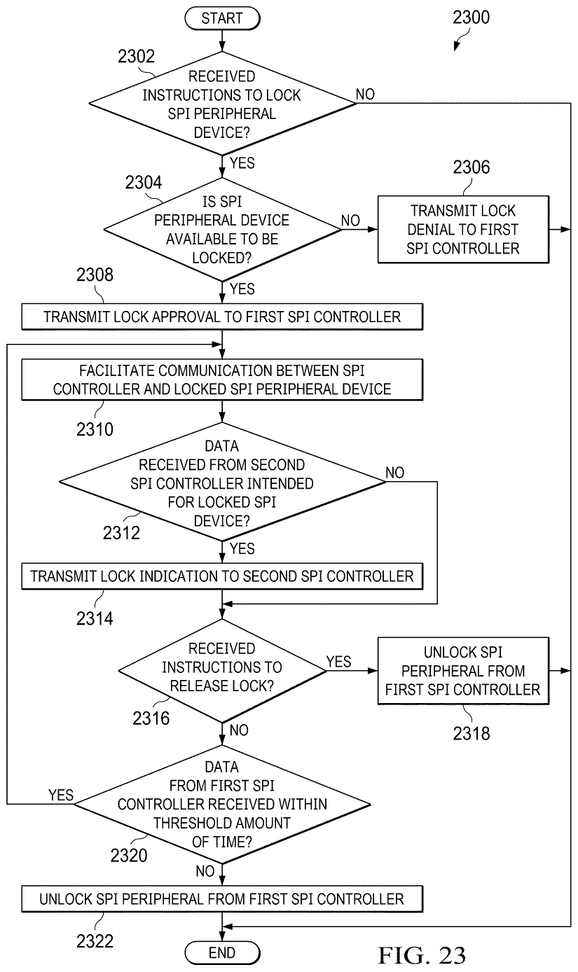

FIG. 22 includes a flowchart of embodiment method 2200, according to an embodiment of the present disclosure. Method 2200 may be at least one of executed, instantiated, or performed by programmable circuitry to implement the proxy SPI peripheral 110 of FIG. 1 to attempt to lock data transfers between the SPI controller 104 and the SPI peripheral device 126. Although the flowchart of FIG. 22 is described in conjunction with the SPI controller 104, the proxy SPI peripheral 110, the proxy SPI controller 118, the SPI peripheral device 126, the flowchart may be described in conjunction with any SPI controller (e.g., such as any one of the SPI controllers 104 or 142), any proxy SPI peripheral (e.g., such as any one of the proxy SPI peripherals 110 or 148), any proxy SPI controller (e.g., such as any one of the proxy SPI controllers 115, 118, 122), and/or any SPI peripheral device (e.g., such as any one of the SPI peripherals 126, 127, 130, 131). The steps/blocks of FIG. 22 are described with respect to the proxy SPI peripheral 110 of FIG. 1.

Method 2200 begins at block 2202, at which the proxy SPI peripheral 110 determines if instructions have been received (e.g., via one of the interface(s) 109) to lock a SPI peripheral device (e.g., the SPI peripheral device 126 of FIG. 1) from the SPI controller 104 via the SPI connection 106 or another dedicated pin/connection. If the proxy SPI peripheral 110 determines that instructions have not been received to lock a SPI peripheral device (block 2202: NO), the instructions end. If the proxy SPI peripheral 110 determines that instructions have been received to lock a SPI peripheral device (block 2202: YES), the proxy SPI peripheral 110 transmits (e.g., using one of the interface(s) 109) lock instructions to the SerDes device connected to the target SPI peripheral device (e.g., the SPI peripheral device to be locked) via the SerDes connection 112 (block 2204). For example, the proxy SPI peripheral 110 transmits an instruction (e.g., a lock request) to the proxy SPI controller 118 of the SerDes device 116 to lock the SPI peripheral device 126 for data transfer with the SPI controller 104. As further described below, the proxy SPI controller 118 returns a lock approval or denial based on the lock request. If the proxy SPI controller 118 approves the lock request, the proxy SPI controller 118 rejects data transfers between the locked SPI peripheral device 126 and any other SPI controller (e.g., the SPI controller 142) for the duration of the lock.

At block 2206, the proxy SPI peripheral 110 determines if a lock approval has been received from the SerDes device. If the proxy SPI peripheral 110 does not receive a lock approval (block 2206: NO), the proxy SPI peripheral 110 transmits (e.g., using one of the interface(s) 109) a lock denial to the SPI controller 104 via the SPI connection 106 (block 2207) and the instructions end. If the proxy SPI peripheral 110 receives a lock approval (block 2206: YES), the proxy SPI peripheral 110 transmits (e.g., using one of the interface(s) 109) lock approval to the SPI controller 104 via the SPI connection 106 (block 2208). At block 2210, the proxy SPI peripheral 110 facilitates communication between the SPI controller 104 and the locked SPI peripheral device 126. For example, the proxy SPI peripheral 110 can obtain read commands, write commands, read and write commands, etc. from the SPI controller 104 using the SPI protocol and transmit the command(s) to the proxy SPI controller 118 using the SerDes protocol via the SerDes network 150. In this manner, the proxy SPI controller 118 can convert the command(s) to the SPI protocol and transmit the SPI-based command(s) to the locked SPI peripheral device 126. Additionally, the proxy SPI peripheral 110 can facilitate the transmission of data (e.g., read payloads, ACKs, etc.) from the SPI peripheral device 126 to the SPI controller 104 via the SerDes network 150. The facilitation of communication between SPI controller 104 and the SPI peripheral device 126 is further described throughout.

At block 2212, the proxy SPI peripheral 110 determines if instructions have been received (e.g., via one of the interface(s) 109) to release the lock from the SPI controller 104. For example, the SPI controller 104 may transmit an instruction, via the SPI connection 106 or a dedicated pin/connection, to release the lock after a data transfer is complete. If the proxy SPI peripheral 110 determines that instructions to release the lock have not been received (block 2212: NO), then instructions return to block 2210 to continue facilitation of communication between the SPI controller 104 and the locked SPI peripheral device 126. If the proxy SPI peripheral 110 determines that instructions to release the lock have been received (block 2212: YES), the proxy SPI peripheral 110 transmits (using one of the interface(s) 109) the unlock instructions to the SerDes device corresponding to the locked SPI peripheral device (block 2214). For example, the proxy SPI peripheral 110 transmits an instruction (e.g., an unlock request) to the proxy SPI controller 118 of the SerDes device 116 to unlock communication of the SPI peripheral device 126 to any SPI controller.

FIG. 23 includes a flowchart of embodiment method 2300, according to an embodiment of the present disclosure. Method 2300 may be at least one of executed, instantiated, or performed by programmable circuitry to implement the proxy SPI controller 118 of FIG. 1 to attempt to lock data transfers between the SPI controller 104 and the SPI peripheral device 126. Although the flowchart of FIG. 23 is described in conjunction with the SPI controller 104, the proxy SPI peripheral 110, the proxy SPI controller 118, the SPI peripheral device 126, the flowchart may be described in conjunction with any SPI controller (e.g., such as the SPI controllers 104, 142), any proxy SPI controller (e.g., such as the proxy SPI controllers 115, 118, 122), any proxy SPI peripheral (e.g., such as proxy the SPI peripherals 110 or 148), and/or any SPI peripheral device (e.g., such as any one of the SPI peripherals 126, 127, 130, 131). The steps/blocks of FIG. 23 are described with respect to the proxy SPI controller 118 of FIG. 1.

Method 2300 begins at block 2302, at which the proxy SPI controller 118 determines whether instructions to lock a connected SPI peripheral device (e.g., the SPI peripheral device 126) have been received via one of the interface(s) 117 from a SPI controller (e.g., the SPI controller 104 via the SerDes network 150. For example, as described above, if the SPI controller 104 wants to lock communication with the SPI peripheral device 126, the SPI controller 104 transmits a lock request to the proxy SPI peripheral 110, which forwards the lock request to the proxy SPI controller 118 via the SerDes connections 112. If the proxy SPI controller 118 determines that instructions to lock a SPI peripheral device have not been received (block 2302: NO), the instructions end. If the proxy SPI controller 118 determines that instructions to lock the SPI peripheral device 126 have been received (block 2302: YES), the proxy SPI controller 118 determines if the SPI peripheral device 126 is available to be locked (block 2304). For example, the proxy SPI controller 118 can determine that the SPI peripheral device 126 is available to be locked if it is operational and not locked with another SPI controller (e.g., the SPI controller 142).

If the proxy SPI controller 118 determines that the SPI peripheral device 126 is not available to be locked (block 2304: NO), the proxy SPI controller 118 transmits (e.g., using one of the interface(s) 117) a lock denial for the SPI peripheral device 126 to the SPI controller 104 via the SerDes connections 112 and the proxy SPI peripheral 110 connected to the SPI controller 104 (block 2306) and the instructions end. If the proxy SPI controller 118 determines that the SPI peripheral device 126 is available to be locked (block 2304: YES), the proxy SPI controller 118 transmits (e.g., using one of the interface(s) 117) a lock approval for the SPI peripheral device 126 to the SPI controller 104 via the SerDes connections 112 and the proxy SPI peripheral 110 connected to the SPI controller 104 (block 2308). At block 2310, the proxy SPI controller 118 facilitates communication between the SPI controller 104 and the locked SPI peripheral device 126 through the SerDes network 150. For example, the proxy SPI controller 118 can obtain read commands, write commands, read and write commands, etc. from the SPI controller 104 via the proxy SPI peripheral 110 using the SerDes protocol and transmit the command(s) to the SPI peripheral device 126 using the SPI protocol. Additionally, the proxy SPI controller 118 can facilitate the transmission of data (e.g., read payloads, ACKs, etc.) from the SPI peripheral device 126 to the SPI controller 104 via the SerDes network 150. The facilitation of communication between SPI controller 104 and the SPI peripheral device 126 is further described throughout.

At block 2312, the proxy SPI controller 118 determines if data from a second SPI controller (e.g., the SPI controller 142) has been received (e.g., via one of the interface(s) 117) for the locked SPI peripheral device 126. If the proxy SPI controller 118 determines that the data from a second SPI controller has not been received (block 2312: NO), control continues to block 2316. If the proxy SPI controller 118 determines that the data from a second SPI controller has been received (block 2312: YES), the proxy SPI controller 118 blocks the transmission of the data to the SPI peripheral device 126 and transmits (e.g., using one of the interface(s) 117) a lock indication to the SPI controller 142 via the SerDes connection 112 and the proxy SPI peripheral 148 (block 2314). At block 2316, the proxy SPI controller 118 determines if instructions have been received (e.g., via one of the interface(s) 117) to release the lock from the SPI controller 104. If the proxy SPI controller 118 determines that instructions to release the lock have not been received (block 2316: NO), control continues to block 2320. If the proxy SPI controller 118 determines that instructions to release the lock have been received (block 2316: YES), the proxy SPI controller 118 unlocks the SPI peripheral device 126 from a lock with the SPI controller 104 (block 2318), and the instructions end. For example, when the SPI peripheral device 126 is unlocked, the proxy SPI controller 118 facilitates communication with the SPI peripheral device 126 and any SPI controller within the system 100 until a subsequent lock request is received.

At block 2320, the proxy SPI controller 118 determines if data from the first SPI controller 104 has been received (e.g., via one of the interface(s) 117) within a threshold amount of time. The threshold amount of time may provide a timeout to automatically unlock a device if there is no data transfer within the threshold amount of time. If the proxy SPI controller 118 determines that data from the SPI controller 104 has been received within the threshold amount of time (block 2320: YES), control returns to block 2310 to continue facilitation between the SPI controller 104 and the locked SPI peripheral device 126. If the proxy SPI controller 118 determines that data from the SPI controller 104 has not been received within the threshold amount of time (block 2320: NO), the proxy SPI controller 118 unlocks the SPI peripheral device 126 from a lock with the SPI controller 104 (block 2322). For example, when the SPI peripheral device 126 is unlocked, the proxy SPI controller 118 facilitates communication with the SPI peripheral device 126 and any SPI controller within the system 100 until a subsequent lock request is received.

While an example manner of implementing the host processors 102, 140, the SPI controllers 104, 142, the SerDes devices 108, 116, 120, 144, the proxy SPI peripherals 110, 148, the proxy SPI controllers 115, 118, 122, the SPI peripheral devices 126, 127, 130, 134, and/or more generally the system 100 of FIG. 1 is illustrated in FIG. 1, one or more of the elements, processes, and/or devices illustrated in FIG. 1 may be combined, divided, re-arranged, omitted, eliminated, and/or implemented in any other way. Further, the host processors 102, 140, the SPI controllers 104, 142, the SerDes devices 108, 116, 120, 144, the proxy SPI peripherals 110, 148, the proxy SPI controllers 115, 118, 122, the SPI peripheral devices 126, 127, 130, 134, and/or more generally the system 100 of FIG. 1, may be implemented by hardware alone or by hardware in combination with software and/or firmware. Thus, for example, any of the host processors 102, 140, the SPI controllers 104, 142, the SerDes devices 108, 116, 120, 144, the proxy SPI peripherals 110, 148, the proxy SPI controllers 115, 118, 122, the SPI peripheral devices 126, 127, 130, 134, and/or more generally the system 100 of FIG. 1, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine readable instructions (e.g., firmware or software). Further still, the host processors 102, 140, the SPI controllers 104, 142, the SerDes devices 108, 116, 120, 144, the proxy SPI peripherals 110, 148, the proxy SPI controllers 115, 118, 122, the SPI peripheral devices 126, 127, 130, 134, and/or more generally the system 100 of FIG. 1 may include one or more elements, processes, and/or devices in addition to, or instead of, those illustrated in FIG. 1, and/or may include more than one of any or all of the illustrated elements, processes and devices.

Flowchart(s) representative of example machine readable instructions, which may be executed by programmable circuitry to implement and/or instantiate the host processors 102, 140, the SPI controllers 104, 142, the SerDes devices 108, 116, 120, 144, the proxy SPI peripherals 110, 148, the proxy SPI controllers 115, 118, 122, the SPI peripheral devices 126, 127, 130, 134, and/or more generally the system 100 of FIG. 1 and/or representative of example operations which may be performed by programmable circuitry to implement and/or instantiate the host processors 102, 140, the SPI controllers 104, 142, the SerDes devices 108, 116, 120, 144, the proxy SPI peripherals 110, 148, the proxy SPI controllers 115, 118, 122, the SPI peripheral devices 126, 127, 130, 134, and/or more generally the system 100 of FIG. 1, are shown in FIGS. 18-23. The machine-readable instructions may be one or more executable programs or portion(s) of one or more executable programs for execution by programmable circuitry. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium.

Although the example program(s) is described with reference to the flowchart(s) illustrated in FIGS. 18-23, many other methods of implementing the host processors 102, 140, the SPI controllers 104, 142, the SerDes devices 108, 116, 120, 144, the proxy SPI peripherals 110, 148, the proxy SPI controllers 115, 118, 122, the SPI peripheral devices 126, 127, 130, 134, and/or more generally the system 100 of FIG. 1 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)).

As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

Example embodiments of the present disclosure are summarized here. Other embodiments can also be understood from the entirety of the specification and the claims filed herein.

Example 1. An apparatus including: interface circuitry configured to: receive, from a first host device and using a first communication protocol, a first data packet designated for an endpoint device; after receiving the first data packet, receive, from a second host device and using the first communication protocol, a second data packet designated for the endpoint device; and control circuitry coupled to the interface circuitry, the control circuitry configured to: lock communication between the endpoint device and the first host device; cause the interface circuitry to transmit, using a second communication protocol, the first data packet to the endpoint device; and discard the second data packet.

Example 2. The apparatus of example 1, where the control circuitry is configured to lock communication between the endpoint device and the first host device based on: receiving a first lock instruction from the first host device prior to receiving a second lock instruction from the second host device; or receiving the first data packet before receiving the second data packet.

Example 3. The apparatus of one of examples 1 or 2, where the control circuitry is configured to cause the interface circuitry to notify the second host device that communication to the endpoint device is locked.

Example 4. The apparatus of one of examples 1 to 3, where the control circuitry is configured to unlock communication between the endpoint device and the first host device based on: a duration of time of no communication from the first host device; and reception of an unlock instruction from the first host device.

Example 5. The apparatus of one of examples 1 to 4, further including a buffer configured to store the first data packet, the interface circuitry configured to release the first data packet from the buffer when the interface circuitry transmits the first data packet to the endpoint device.

Example 6. The apparatus of one of examples 1 to 5, where the control circuitry is configured to: determine when an amount of data in the buffer is above a threshold; and cause the interface circuitry to output a buffer fullness indication to the endpoint device, the first host device, or a Serializer/Deserializer device coupled to the first host device, based on the amount of data in the buffer being above the threshold.

Example 7. The apparatus of one of examples 1 to 6, where the control circuitry is configured to adjust a local clock based on the amount of data in the buffer being above the threshold, a clock signal generated by the local clock used to sample incoming data to the interface circuitry, or transmit outgoing data from the interface circuitry.

Example 8. The apparatus of one of examples 1 to 7, where the endpoint device is a first endpoint device, the interface circuitry configured to be coupled to a plurality of endpoint devices via a shared connection, the plurality of endpoint devices including the first endpoint device and a second endpoint device, the control circuitry configured to cause the interface circuitry to transmit the first data packet to the plurality of endpoint devices.

Example 9. The apparatus of one of examples 1 to 8, where the control circuitry is configured to prior to transmission of the first data packet to the plurality of endpoint devices, identify that the first data packet is to be consumed by the first endpoint device and the second endpoint device.

Example 10. The apparatus of one of examples 1 to 9, where, to cause the interface circuitry to transmit the first data packet to the plurality of endpoint devices, the control circuitry is configured to: cause the interface circuitry to output a first signal at a first terminal, the first signal associated to the first endpoint device; and cause the interface circuitry to output a second signal, at a second terminal, the second signal associated to the second endpoint device.

Example 11. The apparatus of one of examples 1 to 10, where, to cause the interface circuitry to transmit the first data packet to the plurality of endpoint devices, the control circuitry is configured to transmit identifiers of the first and second endpoint devices with the first data packet.

Example 12. The apparatus of one of examples 1 to 11, where the control circuitry is configured to cause the interface circuitry to transmit a single acknowledgment (ACK) to the first host device in response to receiving a first ACK from the first endpoint device and a second ACK from the second endpoint device.

Example 13. The apparatus of one of examples 1 to 12, where the control circuitry is configured to cause the interface circuitry to transmit a no ACK (NACK) in response to not receiving an ACK from at least one of the first endpoint device or the second endpoint device.

Example 14. The apparatus of one of examples 1 to 13, where the first communication protocol is a wired communication protocol that uses a single wire for data and clock signal transmission, and the second communication protocol is a wired communication protocol that uses a first wire for data signals and a second wire for a clock signal.

Example 15. An apparatus including: interface circuitry configured to receive, from a host device and using a first communication protocol, a lock request to lock communication between an endpoint device and the host device; and control circuitry coupled to the interface circuitry and configured to: cause the interface circuitry to transmit, using a second communication protocol, the lock request to the endpoint device; responsive to an approval of the lock request, cause the interface circuitry to route, using the second communication protocol, a first data packet to the endpoint device, the first data packet received by the interface circuitry from the host device; and responsive to reception of an unlock request to unlock communication between the endpoint device and the host device, cause the interface circuitry to route, using the second communication protocol, the unlock request to the endpoint device.

Example 16. The apparatus of example 15, where the host device is a first host device, the control circuitry configured to: cause the interface circuitry to route a second data packet from the first host device to the endpoint device; and in response to reception of an indication that the endpoint device is locked to a second host device, cause the interface circuitry to notify the first host device of a failure to transmit the second data packet.

Example 17. The apparatus of one of examples 15 or 16, where the control circuitry is configured to: determine a routing path to the endpoint device based on additional data; and cause the interface circuitry to transmit the first data packet according to the routing path.

Example 18. The apparatus of one of examples 15 to 17, where the interface circuitry includes: a first interface configured to receive the first data packet; and a second interface, where the additional data is included in a prefix or a suffix of the first data packet, part of the first data packet, received via the second interface, or included in a second data packet received prior to the first data packet.

Example 19. The apparatus of one of examples 15 to 18, where the interface circuitry includes a third interface, where the control circuitry is configured to determine the part of the first data packet that includes the additional data based on a signal received at the third interface.

Example 20. The apparatus of one of examples 15 to 19, further including a buffer configured to store the first data packet, the interface circuitry configured to release the first data packet from the buffer when the interface circuitry routes the first data packet to the endpoint device.

Example 21. The apparatus of one of examples 15 to 20, where the control circuitry is configured to: determine when an amount of data in the buffer is above a threshold; and cause the interface circuitry to output a buffer fullness indication based on the amount of data in the buffer being above the threshold to the endpoint device, the host device, or a Serializer/Deserializer device coupled to the endpoint device.

Example 22. The apparatus of one of examples 15 to 21, where the control circuitry is configured to adjust a local clock based on the amount of data in the buffer being above the threshold, where the interface circuitry is configured to use a clock signal generated by the local clock to sample incoming data or transmit outgoing data.

Example 23. The apparatus of one of examples 15 to 22, where the endpoint device is a first endpoint device, the control circuitry configured to cause the interface circuitry to route the first data packet to the first endpoint device and a second endpoint device.

Example 24. The apparatus of one of examples 15 to 23, where the interface circuitry includes a first interface and a second interface, the control circuitry configured to, prior to routing of the first data packet to the first and second endpoint devices, determine that the first data packet is to be transmitted to the first endpoint device and the second endpoint device based on identifiers of the first and second endpoint devices included in first data packet or received additional data corresponding to the first data packet, or based on a first signal received at the first interface and a second signal received at the second interface.

Example 25. The apparatus of one of examples 15 to 24, where the control circuitry is configured to cause the interface circuitry to transmit a single acknowledgment (ACK) to the host device based on receiving a first ACK from a first Serializer/Deserializer device associated to the first endpoint device and a second ACK from a second Serializer/Deserializer associated to the second endpoint device.

Example 26. The apparatus of one of examples 15 to 25, where the control circuitry is configured to cause the interface circuitry to transmit a no ACK (NACK) based on not receiving an ACK from a first Serializer/Deserializer device associated to the first endpoint device or a second ACK from a second Serializer/Deserializer associated to the second endpoint device.

While this disclosure has been described with reference to illustrative embodiments, this description is not limiting. Various modifications and combinations of the illustrative embodiments, as well as other embodiments, will be apparent to persons skilled in the art upon reference to the description.

What is claimed is:

1. An apparatus comprising:
interface circuitry configured to:
receive, from a first host device and using a first communication protocol, a first data packet designated for an endpoint device;
after receiving the first data packet, receive, from a second host device and using the first communication protocol, a second data packet designated for the endpoint device; and
control circuitry coupled to the interface circuitry, the control circuitry configured to:
lock communication between the endpoint device and the first host device;
cause the interface circuitry to transmit, using a second communication protocol, the first data packet to the endpoint device; and
discard the second data packet.

2. The apparatus of claim 1, wherein the control circuitry is configured to lock communication between the endpoint device and the first host device based on:
receiving a first lock instruction from the first host device prior to receiving a second lock instruction from the second host device; or
receiving the first data packet before receiving the second data packet.

3. The apparatus of claim 1, wherein the control circuitry is configured to cause the interface circuitry to notify the second host device that communication to the endpoint device is locked.

4. The apparatus of claim 1, wherein the control circuitry is configured to unlock communication between the endpoint device and the first host device based on:
a duration of time of no communication from the first host device; and
reception of an unlock instruction from the first host device.

5. The apparatus of claim 1, further including a buffer configured to store the first data packet, the interface circuitry configured to release the first data packet from the buffer when the interface circuitry transmits the first data packet to the endpoint device.

6. The apparatus of claim 5, wherein the control circuitry is configured to:
determine when an amount of data in the buffer is above a threshold; and
cause the interface circuitry to output a buffer fullness indication to the endpoint device, the first host device, or a Serializer/Deserializer device coupled to the first host device, based on the amount of data in the buffer being above the threshold.

7. The apparatus of claim 6, wherein the control circuitry is configured to adjust a local clock based on the amount of data in the buffer being above the threshold, a clock signal generated by the local clock used to sample incoming data to the interface circuitry, or transmit outgoing data from the interface circuitry.

8. The apparatus of claim 1, wherein the endpoint device is a first endpoint device, the interface circuitry configured to be coupled to a plurality of endpoint devices via a shared connection, the plurality of endpoint devices including the first endpoint device and a second endpoint device, the control circuitry configured to cause the interface circuitry to transmit the first data packet to the plurality of endpoint devices.

9. The apparatus of claim 8, wherein the control circuitry is configured to prior to transmission of the first data packet to the plurality of endpoint devices, identify that the first data packet is to be consumed by the first endpoint device and the second endpoint device.

10. The apparatus of claim 8, wherein, to cause the interface circuitry to transmit the first data packet to the plurality of endpoint devices, the control circuitry is configured to:
cause the interface circuitry to output a first signal at a first terminal, the first signal associated to the first endpoint device; and
cause the interface circuitry to output a second signal, at a second terminal, the second signal associated to the second endpoint device.

11. The apparatus of claim 8, wherein, to cause the interface circuitry to transmit the first data packet to the plurality of endpoint devices, the control circuitry is configured to transmit identifiers of the first and second endpoint devices with the first data packet.

12. The apparatus of claim 8, wherein the control circuitry is configured to cause the interface circuitry to transmit a single acknowledgment (ACK) to the first host device in response to receiving a first ACK from the first endpoint device and a second ACK from the second endpoint device.

13. The apparatus of claim 8, wherein the control circuitry is configured to cause the interface circuitry to transmit a no ACK (NACK) in response to not receiving an ACK from at least one of the first endpoint device or the second endpoint device.

14. The apparatus of claim 1, wherein the first communication protocol is a wired communication protocol that uses a single wire for data and clock signal transmission, and the second communication protocol is a wired communication protocol that uses a first wire for data signals and a second wire for a clock signal.

15. An apparatus comprising:
interface circuitry configured to receive, from a host device and using a first communication protocol, a lock request to lock communication between an endpoint device and the host device; and
control circuitry coupled to the interface circuitry and configured to:
cause the interface circuitry to transmit, using a second communication protocol, the lock request to the endpoint device;
responsive to an approval of the lock request, cause the interface circuitry to route, using the second communication protocol, a first data packet to the endpoint device, the first data packet received by the interface circuitry from the host device; and
responsive to reception of an unlock request to unlock communication between the endpoint device and the host device, cause the interface circuitry to route, using the second communication protocol, the unlock request to the endpoint device.

16. The apparatus of claim 15, wherein the host device is a first host device, the control circuitry configured to:
cause the interface circuitry to route a second data packet from the first host device to the endpoint device; and
in response to reception of an indication that the endpoint device is locked to a second host device, cause the interface circuitry to notify the first host device of a failure to transmit the second data packet.

17. The apparatus of claim 15, wherein the control circuitry is configured to:
determine a routing path to the endpoint device based on additional data; and
cause the interface circuitry to transmit the first data packet according to the routing path.

18. The apparatus of claim 17, wherein the interface circuitry includes:
a first interface configured to receive the first data packet; and
a second interface, wherein the additional data is included in a prefix or a suffix of the first data packet, part of the first data packet, received via the second interface, or included in a second data packet received prior to the first data packet.

19. The apparatus of claim 18, wherein the interface circuitry includes a third interface, wherein the control circuitry is configured to determine the part of the first data packet that includes the additional data based on a signal received at the third interface.

20. The apparatus of claim 15, further including a buffer configured to store the first data packet, the interface circuitry configured to release the first data packet from the buffer when the interface circuitry routes the first data packet to the endpoint device.

21. The apparatus of claim 20, wherein the control circuitry is configured to:
determine when an amount of data in the buffer is above a threshold; and
cause the interface circuitry to output a buffer fullness indication based on the amount of data in the buffer being above the threshold to the endpoint device, the host device, or a Serializer/Deserializer device coupled to the endpoint device.

22. The apparatus of claim 21, wherein the control circuitry is configured to adjust a local clock based on the amount of data in the buffer being above the threshold, wherein the interface circuitry is configured to use a clock signal generated by the local clock to sample incoming data or transmit outgoing data.

23. The apparatus of claim 15, wherein the endpoint device is a first endpoint device, the control circuitry configured to cause the interface circuitry to route the first data packet to the first endpoint device and a second endpoint device.

24. The apparatus of claim 23, wherein the interface circuitry includes a first interface and a second interface, the control circuitry configured to, prior to routing of the first data packet to the first and second endpoint devices, determine that the first data packet is to be transmitted to the first endpoint device and the second endpoint device based on identifiers of the first and second endpoint devices included in first data packet or received additional data corresponding to the first data packet, or based on a first signal received at the first interface and a second signal received at the second interface.

25. The apparatus of claim 23, wherein the control circuitry is configured to cause the interface circuitry to transmit a single acknowledgment (ACK) to the host device based on receiving a first ACK from a first Serializer/Deserializer device associated to the first endpoint device and a second ACK from a second Serializer/Deserializer associated to the second endpoint device.

26. The apparatus of claim 23, wherein the control circuitry is configured to cause the interface circuitry to transmit a no ACK (NACK) based on not receiving an ACK from a first Serializer/Deserializer device associated to the first endpoint device or a second ACK from a second Serializer/Deserializer associated to the second endpoint device.
